(19) United States
(12) Patent Application Publication
(10) Pub. No.: US 2025/0133457 A1
(43) Pub. Date: Apr. 24, 2025

(54) FAST PCI CONFLICT DETECTION AND RESOLUTION

(71) Applicant: QUALCOMM Incorporated, San Diego, CA (US)

(72) Inventors: Naeem AKL, Bridgewater, NJ (US); Karl Georg HAMPEL, Jersey City, NJ (US); Navid ABEDINI, Basking Ridge, NJ (US); Junyi LI, Fairless Hills, PA (US)

(21) Appl. No.: 18/489,357

(22) Filed: Oct. 18, 2023

(51) Int. Cl. H04W 36/06; H04W 76/11

(52) U.S. Cl. CPC H04W 36/06; H04W 76/11

(57) ABSTRACT

Methods, systems, and devices for fast physical cell identifier (PCI) conflict detection are described. A user equipment (UE) may receive, via a serving cell, a first set of one or more signals indicating a first PCI of the serving cell. After receiving the first set of one or more signals, the UE may receive a control message indicating that the first PCI of the serving cell is changing to a second PCI. The UE may monitor for a second set of one or more signals indicating the second PCI based at least in part on the control message. The UE may receive the second set of one or more signals indicating the second PCI based on the control message, and communicate one or more messages with the serving cell based on the second PCI.

### FIELD OF TECHNOLOGY

The following relates to wireless communications, including fast physical cell identifier (PCI) conflict detection and resolution.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

A UE may distinguish one cell from another based on their respective physical cell identifiers (PCIs). In some cases, however, if two neighbor cells share the same PCI, the UE may experience setup failures, dropped calls, handover issues, channel interference, and the like.

### SUMMARY

The described techniques relate to improved methods, systems, devices, and apparatuses that support fast PCI conflict detection and resolution. For example, the described techniques provide for communications between a user equipment (UE) and a serving cell. The UE may receive, via a serving cell, a first set of one or more signals indicating a first physical cell identifier (PCI) of the serving cell. After receiving the first set of one or more signals, the UE may receive a control message indicating that the first PCI of the serving cell is changing to a second PCI. The UE may monitor for a second set of one or more signals indicating the second PCI based at least in part on the control message. The UE may receive the second set of one or more signals indicating the second PCI based on the control message, and communicate one or more messages with the serving cell based on the second PCI.

A method for wireless communications by the UE is described. The method may include receiving, via a serving cell, a first set of one or more signals indicating a first PCI of the serving cell, receiving, via the serving cell subsequent to receipt of the first set of one or more signals, a control message indicating that the first PCI of the serving cell is changing to a second PCI, and monitoring for a second set of one or more signals indicating the second PCI based on the control message.

A UE for wireless communications is described. The UE may include one or more memories storing processor executable code, and one or more processors coupled with the one or more memories. The one or more processors may individually or collectively operable to execute the code to cause the UE to receive, via a serving cell, a first set of one or more signals indicating a first PCI of the serving cell, receive, via the serving cell subsequent to receipt of the first set of one or more signals, a control message indicating that the first PCI of the serving cell is changing to a second PCI, and monitor for a second set of one or more signals indicating the second PCI based on the control message.

Another UE for wireless communications is described. The UE may include means for receiving, via a serving cell, a first set of one or more signals indicating a first PCI of the serving cell, means for receiving, via the serving cell subsequent to receipt of the first set of one or more signals, a control message indicating that the first PCI of the serving cell is changing to a second PCI, and means for monitoring for a second set of one or more signals indicating the second PCI based on the control message.

A non-transitory computer-readable medium storing code for wireless communications is described. The code may include instructions executable by a processor to receive, via a serving cell, a first set of one or more signals indicating a first PCI of the serving cell, receive, via the serving cell subsequent to receipt of the first set of one or more signals, a control message indicating that the first PCI of the serving cell is changing to a second PCI, and monitor for a second set of one or more signals indicating the second PCI based on the control message.

In some examples of the method, UEs, and non-transitory computer-readable medium described herein may further include operations, features, means, or instructions for receiving the second set of one or more signals indicating the second PCI based on the control message and communicating one or more messages with the serving cell based on the second PCI.

In some examples of the method, UEs, and non-transitory computer-readable medium described herein may further include operations, features, means, or instructions for receiving, from a neighboring cell, a master information block or a system information block including a subset of a cell global identity (CGI) value or a hash of the CGI value.

In some examples of the method, UEs, and non-transitory computer-readable medium described herein may further include operations, features, means, or instructions for transmitting a report to the serving cell including at least the subset of the CGI value or the hash of the CGI value.

In some examples of the method, UEs, and non-transitory computer-readable medium described herein may further include operations, features, means, or instructions for receiving, from the serving cell, a master information block and a system information block, where the master information block includes a first portion of a subset of a CGI value and the system information block includes a second portion of the subset of the CGI value.

In some examples of the method, UEs, and non-transitory computer-readable medium described herein, receiving the control message may include operations, features, means, or instructions for receiving, from the serving cell, a master information block indicating that the first PCI of the serving cell may be changing to the second PCI.

In some examples of the method, UEs, and non-transitory computer-readable medium described herein may further include operations, features, means, or instructions for transmitting a report to the serving cell indicating at least a subset of a CGI value or a hash of the CGI value, where the control message may be received based on the report indicating matching PCI and frequency information and mismatching subsets of CGI values.

In some examples of the method, UEs, and non-transitory computer-readable medium described herein may further include operations, features, means, or instructions for transmitting a mobile history report to the serving cell including at least a subset of a CGI value or a hash of the CGI value.

In some examples of the method, UEs, and non-transitory computer-readable medium described herein may further include operations, features, means, or instructions for performing a cell selection procedure to select a cell for wireless connectivity subsequent to transitioning from an idle state to an active state in accordance with a discontinuous reception cycle, receiving, from the cell, a master information block including a subset of a CGI value, and confirming, based on the subset of the CGI value, that the cell may be the serving cell and that a cell identity of the serving cell may have changed from the first PCI to the second PCI.

In some examples of the method. UEs, and non-transitory computer-readable medium described herein may further include operations, features, means, or instructions for performing a cell selection procedure to select a cell for wireless connectivity subsequent to transitioning from an idle state to an active state in accordance with a discontinuous reception cycle, receiving, from the cell, a system information block including a CGI value, and confirming, based on the CGI value, that the cell may be the serving cell and that a cell identity of the serving cell may have changed from the first PCI to the second PCI.

In some examples of the method, UEs, and non-transitory computer-readable medium described herein may further include operations, features, means, or instructions for communicating one or more messages, where at least a portion of the one or more messages may be scrambled according the first PCI prior to a time indicated in the control message for changing of the first PCI to the second PCI.

In some examples of the method, UEs, and non-transitory computer-readable medium described herein may further include operations, features, means, or instructions for communicating one or more messages, where at least a portion of the one or more messages may be scrambled according the second PCI after a time indicated in the control message for changing of the first PCI to the second PCI.

In some examples of the method, UEs, and non-transitory computer-readable medium described herein may further include operations, features, means, or instructions for receiving the second set of one or more signals indicating the second PCI based on the control message.

In some examples of the method, UEs, and non-transitory computer-readable medium described herein may further include operations, features, means, or instructions for transmitting a first message, where at least a portion of the first message may be scrambled according the first PCI and transmitting a second message that may be a retransmission of the first message, where at least a portion of the second message may be scrambled according the first PCI after a time indicated in the control message for changing of the first PCI to the second PCI.

In some examples of the method, UEs, and non-transitory computer-readable medium described herein may further include operations, features, means, or instructions for communicating one or more messages, where at least a portion of the one or more messages may be scrambled according the second PCI, a subset of a CGI value of the serving cell, a hash of the CGI value, or any combination thereof.

In some examples of the method, UEs, and non-transitory computer-readable medium described herein, the control message may be part of a master information block or other message.

In some examples of the method, UEs, and non-transitory computer-readable medium described herein, the control message indicates the second PCI, a time that the first PCI of the serving cell may be changing to the second PCI, or both.

In some examples of the method, UEs, and non-transitory computer-readable medium described herein, the control message includes an indication of a PCI modification period, the PCI modification period indicates a duration of time that the first PCI of the serving cell may be changing to the second PCI.

A method for wireless communications by a serving cell is described. The method may include transmitting, to a UE, a first set of one or more signals indicating a first PCI of the serving cell, transmitting, subsequent to transmission of the first set of one or more signals, a control message indicating that the first PCI of the serving cell is changing to a second PCI, and communicating one or more messages with the UE based on the second PCI.

A serving cell for wireless communications is described. The serving cell may include one or more memories storing processor executable code, and one or more processors coupled with the one or more memories. The one or more processors may individually or collectively operable to execute the code to cause the serving cell to transmit, to a UE, a first set of one or more signals indicating a first PCI of the serving cell, transmit, subsequent to transmission of the first set of one or more signals, a control message indicating that the first PCI of the serving cell is changing to a second PCI, and communicate one or more messages with the UE based on the second PCI.

Another serving cell for wireless communications is described. The serving cell may include means for transmitting, to a UE, a first set of one or more signals indicating a first PCI of the serving cell, means for transmitting, subsequent to transmission of the first set of one or more signals, a control message indicating that the first PCI of the serving cell is changing to a second PCI, and means for communicating one or more messages with the UE based on the second PCI.

A non-transitory computer-readable medium storing code for wireless communications is described. The code may include instructions executable by a processor to transmit, to a UE, a first set of one or more signals indicating a first PCI of the serving cell, transmit, subsequent to transmission of the first set of one or more signals, a control message indicating that the first PCI of the serving cell is changing to a second PCI, and communicate one or more messages with the UE based on the second PCI.

Some examples of the method, serving cells, and non-transitory computer-readable medium described herein may further include operations, features, means, or instructions for transmitting a second set of one or more signals indicating the second PCI based on the control message.

Some examples of the method, serving cells, and non-transitory computer-readable medium described herein may further include operations, features, means, or instructions for receiving a report from the UE indicating at least a subset of a CGI value or a hash of the CGI value.

Some examples of the method, serving cells, and non-transitory computer-readable medium described herein may further include operations, features, means, or instructions for transmitting, to the UE, a master information block and a system information block, where the master information block includes a first portion of a subset of a CGI value and the system information block includes a second portion of the subset of the CGI value.

In some examples of the method, serving cells, and non-transitory computer-readable medium described herein, transmitting the control message may include operations, features, means, or instructions for transmitting, to the UE, a master information block indicating that the first PCI of the serving cell may be changing to the second PCI.

Some examples of the method, serving cells, and non-transitory computer-readable medium described herein may further include operations, features, means, or instructions for receiving a report from the UE indicating at least a subset of a CGI value or a hash of the CGI value, where the control message may be transmitted based on the report indicating matching PCI and frequency information and mismatching subsets of CGI values.

Some examples of the method, serving cells, and non-transitory computer-readable medium described herein may further include operations, features, means, or instructions for receiving a mobile history report from the UE including at least a subset of a CGI value or a hash of the CGI value.

Some examples of the method, serving cells, and non-transitory computer-readable medium described herein may further include operations, features, means, or instructions for communicating one or more messages, where at least a portion of the one or more messages may be scrambled according the first PCI prior to a time indicated in the control message for changing of the first PCI to the second PCI.

Some examples of the method, serving cells, and non-transitory computer-readable medium described herein may further include operations, features, means, or instructions for communicating one or more messages, where at least a portion of the one or more messages may be scrambled according the second PCI after a time indicated in the control message for changing of the first PCI to the second PCI.

Some examples of the method, serving cells, and non-transitory computer-readable medium described herein may further include operations, features, means, or instructions for communicating one or more messages, where at least a portion of the one or more messages may be scrambled according the second PCI, a subset of a CGI value of the serving cell, a hash of the CGI value, or any combination thereof.

### BRIEF DESCRIPTION OF THE DRAWINGS

FIG. 1 through 3 show examples of wireless communications systems that support fast physical cell identifier (PCI) conflict detection and resolution in accordance with one or more aspects of the present disclosure.

FIG. 4 shows an example of a process flow that supports fast PCI conflict detection and resolution in accordance with one or more aspects of the present disclosure.

FIGS. 5 and 6 show block diagrams of devices that support fast PCI conflict detection and resolution in accordance with one or more aspects of the present disclosure.

FIG. 7 shows a block diagram of a communications manager that supports fast PCI conflict detection and resolution in accordance with one or more aspects of the present disclosure.

FIG. 8 shows a diagram of a system including a device that supports fast PCI conflict detection and resolution in accordance with one or more aspects of the present disclosure.

FIGS. 9 and 10 show block diagrams of devices that support fast PCI conflict detection and resolution in accordance with one or more aspects of the present disclosure.

FIG. 11 shows a block diagram of a communications manager that supports fast PCI conflict detection and resolution in accordance with one or more aspects of the present disclosure.

FIG. 12 shows a diagram of a system including a device that supports fast PCI conflict detection and resolution in accordance with one or more aspects of the present disclosure.

FIGS. 13 through 16 show flowcharts illustrating methods that support fast PCI conflict detection and resolution in accordance with one or more aspects of the present disclosure.

FIG. 17 shows an example of a network architecture that supports techniques for relaying inter-CU communications in accordance with one or more aspects of the present disclosure.

### DETAILED DESCRIPTION

In some wireless communications systems, a user equipment (UE) may communicate with a cell. Each cell may have a corresponding physical cell identifier (PCI) value. A UE uses different PCIs to differentiate between cells of a network, and to determine and decode physical layer data received from a cell. The UE searches a space for the PCI, such as when connecting with the network. The larger the number of possible PCIs, the larger the space the UE has to search, increasing costs for the UE. Thus, there is a limited number of PCIs the UE can detect. Due to the limited number of PCIs, adjacent cells may have the same PCI and frequency, causing the UE to be unable to distinguish between cells. If two cells share the same PCI (referred to as a PCI conflict), the UE may experience setup failures, dropped calls, handover issues, channel interference, etc. PCI conflicts may include PCI confusion (where two neighboring cells have the same PCI value) or PCI collision (where a serving cell and a neighboring cell have the same PCI value). PCI conflicts may occur more frequently in denser cell deployments, mobile networks, and aerial UE systems, among other examples.

In some cases, network planning may reduce or minimize the prevalence of PCI conflicts. For example, the UE may receive system information from a neighboring cell, and transmit the system information to a serving cell. The serving cell may receive multiple system information indications from multiple UEs and identify PCI conflicts by comparing the received information. After PCI conflict detection, in some cases, the UE may not support PCI reconfiguration of a serving cell. In some examples, a connected UE may undergo radio link failure if the PCI of the cell changes, or if the UE experiences handover. If the PCI of the cell changes while a UE is an idle (e.g., inactive) state, the UE may perform cell reselection and require retransmission or additional system information. Such approaches may be time consuming and require significant resources, increasing overhead for the UE, and PCI conflicts that do occur may persist for a relatively long time.

In accordance with aspects of the present disclosure, techniques described herein provide for fast PCI conflict detection and resolution. The UE may include a subset of the cell global identity (CGI) value of a neighboring cell as part of a report to the serving cell. Such a value has minimal to negligent additional overhead for the UE. The serving cell may receive multiple subsets of CGI values from multiple UEs, and compare received values to identify PCI conflicts. If the UE is in a connected state, the UE may transmit the subset of the CGI value as part of a measurement report. If the UE is in an inactive or idle state, the UE may transmit the subset of the CGI value as part of a mobility history report.

In some examples, such as after PCI conflict detection, the PCI may be reconfigured by the serving cell using a non-disruptive method, where the UE may receive a message informing the UE of an upcoming PCI change for the serving cell. The message may be unicast, a group message, or a dynamic message. If the UE is in a connected state, the UE updates the PCI, but does not disconnect from the serving cell and reestablish connection with the serving cell. Rather, the UE remains in the connected state with the serving cell and merely updates the PCI. If the UE is in an inactive or idle state, the UE may miss the notice of the upcoming PCI change, and confirm cell identity via information from the serving cell.

Aspects of the disclosure are initially described in the context of wireless communications systems and process flows. Aspects of the disclosure are further illustrated by and described with reference to apparatus diagrams, system diagrams, flowcharts, and network architecture that relate to fast PCI conflict detection and resolution.

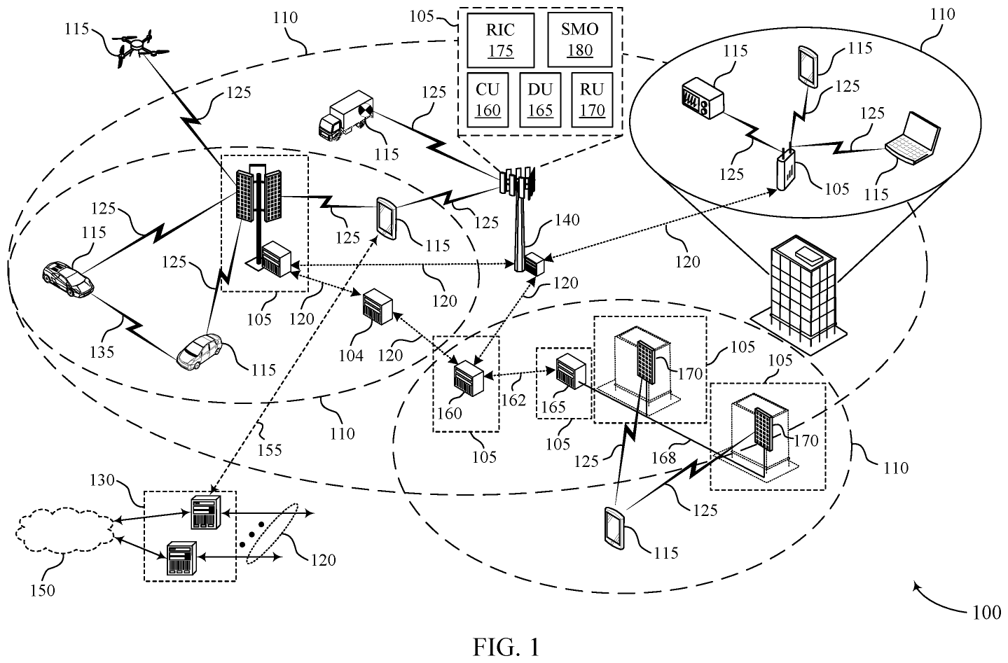

FIG. 1 shows an example of a wireless communications system 100 that supports fast PCI conflict detection and resolution in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (cNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c. F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support fast PCI conflict detection and resolution as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δƒ) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHZ, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, the UE 115 may communicate with one or more cells. In some examples, a network entity 105 may include one or more cells, or a network entity 105 may be referred to as a cell. Each cell may have a corresponding PCI value, which the UE 115 may use for handover between cells of a network, and to determine and decode physical layer data received from a cell. If two different nearby cells share the same PCI, PCI conflict may occur, and the UE 115 may experience setup failures, dropped calls, handover issues, channel interference, etc. PCI conflicts can include PCI confusion (where two neighbor cells have the same PCI value) or PCI collision (where a serving cell and a neighbor cell have the same PCI value). In some cases, network planning can reduce or minimize the prevalence of PCI conflicts, but PCI conflicts may still result.

Techniques described herein provide for fast PCI conflict detection and resolution. The UE 115 may include a subset of the CGI value of the neighboring cell as part of a report to the serving cell. The serving cell may receive multiple subsets of CGI values from multiple UEs 115, and compare the values to identify PCI conflicts. If the UE 115 is in a connected state, the UE 115 may transmit the subset of the CGI value as part of a measurement report. If the UE 115 is in an inactive or idle state, the UE 115 may transmit the subset of the CGI value as part of a mobility history report.

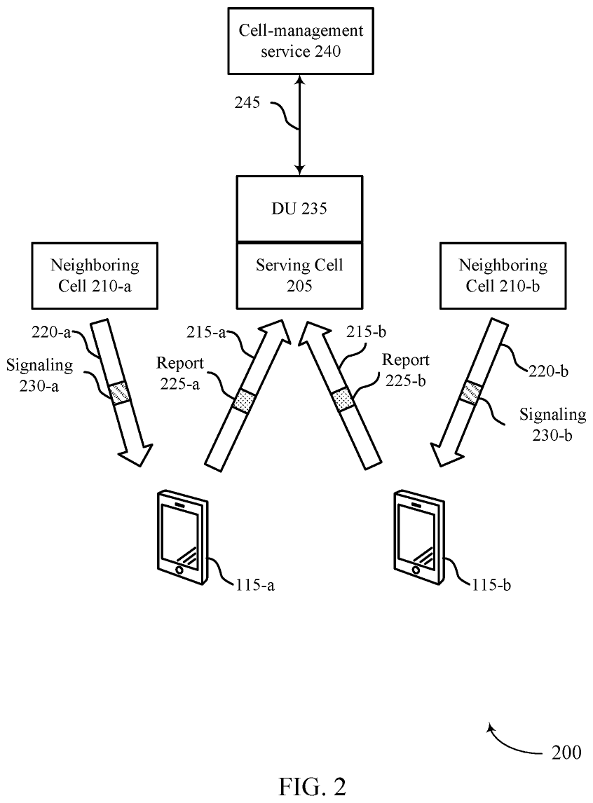

After PCI conflict detection, the PCI may be reconfigured by the serving cell using a non-disruptive method, where the UE 115 may receive a message informing the UE 115 of an upcoming PCI change. The message may be unicast, a group message, or a dynamic message. If the UE 115 is in a connected state, the UE 115 updates the PCI, but does not disconnect from the serving cell and reestablish connection with the serving cell. Rather, the UE 115 remains in the connected state with the serving cell, updates the PCI for the serving cell, and uses the PCI for sending and receiving communications with the serving cell. If the UE 115 is in an inactive or idle state, the UE 115 may miss the notice of the upcoming PCI change, and confirm cell identity via information from the serving cell. Fast PCI conflict detection and resolution is further described in FIGS. 2 through 4.

FIG. 2 shows an example of a wireless communications system 200 that supports fast PCI conflict detection and resolution in accordance with one or more aspects of the present disclosure. The wireless communications system 200 describes an example of communications between UEs 115 and cells that support fast PCI conflict detection. The one or more UEs 115 may be examples of the UE 115 as described with reference to FIG. 1.

The serving cell 205 (e.g., one or more serving cells) and one or more neighboring cells 210 (e.g., neighboring cell 210-a, neighboring cell 210-b), may be in communication with one or more UEs 115 (e.g., UE 115-a, UE 115-b). For example, the serving cell 205 may communicate a report 225-a with the UE 115-b via a link 215-a, and communicate a report 225-b with the UE 115-b via a link 215-b. The link 215-a and the link 215-b may be examples of uplink communications. The neighboring cell 210-a may communicate signaling 230-a with the UE 115-a via a link 220-a. The neighboring cell 210-b may communicate signaling 230-b with the UE 115-b via a link 220-b. The link 220-a and the link 220-b may be examples of downlink communications. The serving cell 205 may communicate with a DU 235, which may be an example of the DU 165 as described with reference to FIG. 1. The DU 235 may transmit and receive communications with a cell-management service 240 via link 245.

The signaling 230 may include system information, such as a master information block (MIB) or a system information block (SIB). The system information may include a subset of the CGI value or a hash of the CGI value, or another shortened version of the full CGI value. The report 225 may include the subset of the CGI value (e.g., hash of the CGI value, hashed CGI value, shortened CGI, short CGI, etc.) For example, the signaling 230-a and the report 225-a may include a subset of the CGI value associated with the neighboring cell 210-a, and the signaling 230-b and the report 225-b may include a subset of the CGI value associated with the neighboring cell 210-b.

As described herein, a cell, such as the neighboring cells 210 and serving cell 205, may communicate via a set of one or more frequencies (such as a carrier frequency of a network entity) and a coverage area (such as a geographic zone served by the network entity). In some examples, the neighboring cells 210 and the serving cell 205 may be examples of the network entity 105 as described with reference to FIG. 1. In some examples, each cell may have a corresponding PCI value between 0 and 1008. As the number of cells may exceed the number of possible PCI values, the PCI values may be reused by multiple, different cells within the topology of a radio access network. The serving cell 205 may signal (e.g., indicate) a PCI value assigned to the serving cell 205. The PCI value of a cell may be used for various purposes, including (but not limited to) cell search, cell selection, scrambling/descrambling, measurement reporting, etc.

The PCI value may enable the UE 115 to distinguish a particular cell from other cells in the same frequency and/or coverage area. In some cases, however, if two cells share the same PCI, resulting in a PCI conflict, the UE 115-a may experience setup failures, dropped calls, handover issues, channel interference, etc. Such conflicts may be more common in dense deployments, mobile-node networks, and aerial UE applications, among other examples. PCI conflicts can include PCI confusion (where two neighboring cells 210 have the same PCI value) or PCI collision (where a serving cell 205 and a neighboring cell 210 have the same PCI value). As an example, PCI confusion may occur if the neighboring cell 210-a and the neighboring cell 210-b have the same PCI values. PCI collision may occur if the serving cell 205 and the neighboring cell 210-a have the same PCI value.

In some cases, network planning may help mitigate PCI conflicts. For example, the UE 115 may receive a SIB from the neighboring cell 210 that includes an entire CGI. The UE 115 may include the CGI as part of a measurement report to the serving cell 205 (e.g., report 225). In some examples, the measurement report may be configured, such as by a network entity, the cell, or the network. The serving cell 205 may receive multiple reports 225 from multiple UEs and identify a PCI conflict by comparing the reports 225. For example, the signaling 230-a may include a first CGI as part of a first SIB, and the signaling 230-b may include a second CGI as part of a second SIB. The UE 115-a may receive the signaling 230-a and report the SIB to the serving cell 205 as part of the report 225-a and the UE 115-b may receive the signaling 230-b and report the SIB to the serving cell 205 as part of the report 225-b. The serving cell 205 may receive the reports 225 and compare the SIBs including the first and second CGI values and identify PCI conflicts. However, such approaches may be somewhat resource-intensive, increasing overhead for the UE 115, and PCI conflicts that do occur may persist for a relatively long time. In some examples, such as dense networks with replays, subscriber-based infostructure, and moving infrastructure, faster and more efficient PCI conflict detection and resolution may be advantageous. Techniques described herein provide for fast and efficient PCI conflict detection and resolution.

As described in FIG. 2, the UE 115 may receive signaling 230 from a neighboring cell 210. The signaling 230 may include a subset of a CGI value (e.g., hashed value of the CGI, short CGI, a portion of the CGI) assigned to the neighboring cell 210, and the UE 115 may transmit, to the serving cell 205, the subset of the CGI value received in the signaling 230 as part of a MIB in the report 225. The subset of the CGI value may be a hash of the CGI value, or another shortened version of the CGI value. In some examples, the subset of the CGI value may be included in the signaling 230 as part of a SIB or a MIB, or both (e.g., a first portion of the CGI as part of a SIB and a second portion of the CGI as part of a MIB). In some examples, the UE may transmit the subset of the CGI value as part of a SIB. In some examples, a first portion portion of CGI may be carried in MIB, and a second portion of the CGI may be carried in SIB, and together the two portions may be combined (e.g., concatenated) to form the entire CGI . . .

Such addition of the subset of the CGI value to the MIB may reduce overhead of the UE 115, and increase ease and speed of CGI reporting of the UE 115. The serving cell 205 may be able to receive more reports including the subsets of CGI values more quickly, and identify PCI conflicts in a timely manner by comparing the shorter CGI values. The report 225 may be a mobile history report or a measurement report.

For example, the UE 115-a may receive a subset of the CGI value (e.g., hashed CGI, or shortened CGI, short CGI) from the neighboring cell 210-a (e.g., as part of a MIB) as part of the signaling 230-a, where the subset of the CGI identifies the neighboring cell 210-a. The UE 115-b may receive a subset of the CGI value assigned to the neighboring cell 210-b as part of the signaling 230-b, and transmit the subset of the CGI to the serving cell 205 as part of the MIB in the report 225-b, where the subset of the CGI identifies the neighboring cell 210-b. The serving cell 205 may receive the report 225-a indicating the subset of the CGI assigned to the neighboring cell 210-a and the report 225-b indicating the subset of the CGI assigned to the neighboring cell 210-b. That is, each UE 115 may receive a CGI subset associated with the connected neighboring cell 210, and forward the CGI subset to the serving cell 205.

In some examples, the DU 235 (e.g., eDU) or the cell-management service 240 may trigger PCI reconfiguration of one or more cells. The DU 235, the cell-management service, or both, may receive and compare the reports 225. The DU 235 may receive reports 225, such as measurement reports, from one or more cells (e.g., the serving cell 205). Additionally or alternatively, the DU 235 may receive the reports 225 from the UEs 115. In some examples, the cell-managements service may receive one or more reports 225 from the DU 235, one or more cells (e.g., serving cell 205), one or more UEs 115, or a combination thereof.

In some examples, the reports 225 may include subsets of CGIs, as well as frequency and PCI information (e.g., as part of the MIB). For example, a UE may receive a first MIB that indicates frequency information, such as an operating frequency band used by a cell, PCI information, which indicates a PCI value assigned to the cell, and a subset of the CGI of the cell. The UE 115 may send a first report 225 that may include the frequency information, PCI information, and a subset of the CGI of the cell. The UE 115 may also receive a second MIB that indicates frequency information, PCI information, and a subset of the CGI, and may send a second report 225.

A conflict (e.g., confusion, collision) may occur when the PCIs and frequency information in the two reports 225 are the same, but the subsets of the CGIs are different. For example, the DU 235 (e.g., or the cell-management service 240) may compare the PCIs, frequency information, and subsets of the CGI values (e.g., short CGI values). The DU 235 may determine there is a collision or confusion if two or more reports have matching PCI and frequency information, and mismatching short CGI information (e.g., the two subsets of the CGI values in the two reports 225 do not match).

For example, if there is a PCI confusion, the neighboring cells 210 may have the same PCI. In such an example, the report 225-a and the report 225-b may have the same PCI and frequency information. However, the report 225-a may include a first short CGI of the neighboring cell 210-a, and the report 225-b may include the second short CGI of the neighboring cell 210-b, indicating that the two reports 225 came from different cells. The DU 235 may receive both the report 225-a and the report 225-b, and determine that because the PCI and frequency are the same, but the short CGI values are different, that two different cells are using the same PCI. After determining the PCI conflict, the DU 235 may trigger a PCI reconfiguration. In some examples, the serving cell 205, the cell-management service 240, or a combination thereof may identify matching PCI and frequency information and mismatching subsets of CGI values, thus identifying PCI conflicts.

In some examples, the subset of the CGI may be configured by the DU 235 and reported to the cell-management service 240 via the link 245. In some other examples, the DU 235 may report information of the serving cell 205 to the cell-management service 240, and the sell-managements service may configure the subset of the CGI value on the DU 235. The DU 235 may communicate the subset of the CGI value to one or more cells and UE 115, such as the neighboring cells 210.

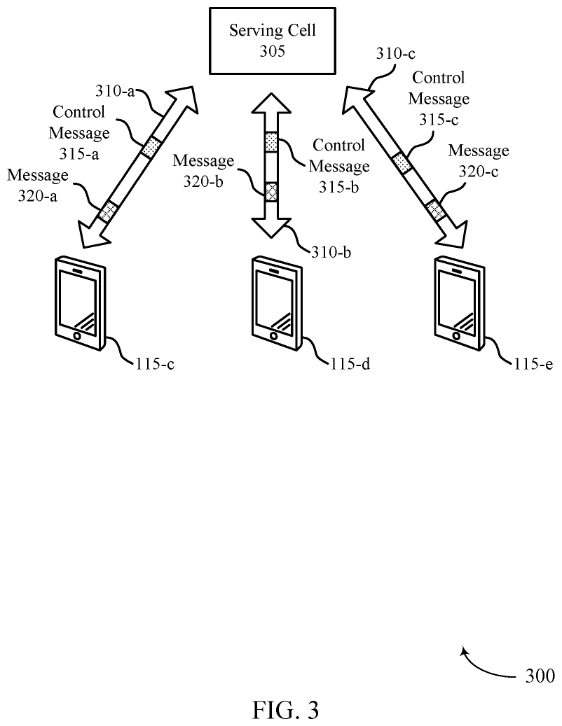

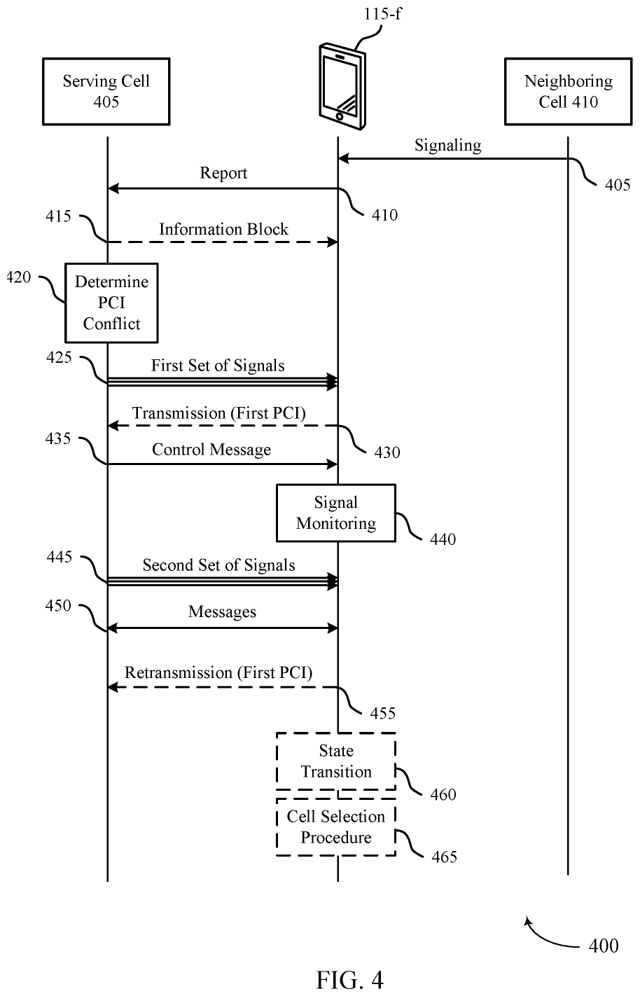

The fast resolution of PCI conflict is further described with reference to FIGS. 3 and 4.

FIG. 3 shows an example of a wireless communications system 300 that supports fast PCI conflict detection and resolution in accordance with one or more aspects of the present disclosure. The wireless communications system 300 may implement one or more aspects of the wireless communications systems shown and described with reference to FIGS. 1 and 2. The wireless communications system 300 describes the resolution of detected conflict detection via communications between a serving cell 205 and UEs 115 (e.g., UE 115-c, UE 115-d, UE 115-e). The serving cell 205 and the UE 115 may communicate via the communications links 310 (e.g., link 310-a, link 310-b, link 310-c). Communications may include control messages 315 (e.g., control message 315-a, control message 315-b, control message 315-c) and messages 320 (e.g., message 320-a, message 320-b, message 320-c). The serving cell 305 may be an example of the serving cell 205 as described with reference to FIG. 2. The UEs 115 (e.g., the UE 115-c, the UE 115-d, the UE 115-e) may be examples of the UE 115 as described with reference to FIG. 2.

In some cases, the network may reconfigure PCIs. A UE 115 may be in a connected state or an idle (e.g., inactive state). In some examples, a connected UE 115 may undergo radio-link failure (RLF) if the PCI of the serving cell 205 changes, or if the UE 115 experiences handover. An idle UE 115 may perform cell reselection and require system information. However, such approaches may be somewhat resource-intensive, increasing overhead for the UE 115, and PCI conflicts that do occur may persist for a relatively long time. Techniques described herein provide for fast and efficient PCI reconfiguration.

To support fast PCI conflict resolution, the serving cell 305 may communicate an upcoming PCI change via a control message 315. The message may be unicast, a group message, or a dynamic message. The control message 315 may be one or more control messages 315, directed to one or more UEs 115. For example, the serving cell 305 may transmit separate control messages 315 to each UE 115, such as transmitting the control message 315-a to the UE 115-c and transmitting the control message 315-b to the UE 115-d. The UE 115 may transmit the message 320 according to the updated PCI.

If the UE 115 is in a connected state, the UE 115 may receive the control message 315 indicating the upcoming PCI change, and maintain connection with the serving cell 305, communicating with the serving cell 305 using the changed PCI, instead of performing a RLF procedure or a handover procedure. If the UE 115 is in an idle (e.g., inactive) state, the UE 115 may fail to receive the control message 315 indicating the upcoming PCI change. Upon entering an active state, such as according to a DRX cycle, the UE 115 may monitor for available cells, select a cell, and receive a MIB from that cell.

For example, as it is possible the PCI value has changed, the UE 115 may check to see if the cell is the same serving cell the UE 115 was connected to before transitioning to the idle state. To do so, the UE 115 may receive a MIB from the cell, and determine if the subset of the CGI value in the MIB is the same as the subset of the CGI value of the cell prior to entering an inactive state. If so, the UE 115 may determine that the cell is the serving cell 305, and is the same cell the UE 115 was connected to before the entering the inactive state. The UE 115 may then refrain from performing a reselection procedure. For example, the UE 115 may skip acquiring a full SIB of the serving cell 305 because the UE 115 has determined that the UE 115 is connected to the same serving cell 305.

In some examples, such as for additional confirmation that the cell is the same serving cell, but with a new PCI value, the UE 115 may acquire, from the cell after entering the active state, a SIB including a full CGI, to confirm that the cell is the same serving cell as before. If the CGI included in the SIB is the same, the UE 115 determines that the cell is the same serving cell 305 (i.e., the cell is the same serving, but with a different PCI) and does not trigger the performance of other reselection procedures.

In some examples, the serving cell 305 may request, such as via the control message 315-a, the UE 115 to include the subset of the CGI in a mobility history report. In some examples, the serving cell 305 may transmit the request after the UE 115 enters an idle mode. In some examples, the UE 115 may transmit the mobility history report that includes the subset of the CGI with or without receiving a request from the serving cell 305.

Prior to receiving the control message 315, the UE 115 may receive, via the serving cell 305, one or more signals indicating the PCI of the serving cell 305. For example the UE 115 may monitor one or more time occasions for one or more transmissions of a signal by a cell, where the signal may include a PCI value of the cell, frequency information of the cell, a subset of the CGI of the cell, or any combination thereof. In some examples, the UE 115 may receive a PCI value in multiple time occasions and use the PCI value to establish connectivity (e.g., establish an association) with the cell, where the cell becomes the serving cell 305 of the UE 115. In some examples, establishing an associating refers to the UE 115 connecting to a cell. In some examples, establishing an association with a cell refers to the UE 115 selecting the cell as the serving cell 305, reselecting the cell as the serving cell 305, camping on the cell, or any combination thereof.

Based on the association established between the UE 115 and the serving cell 305, the serving cell 305 may transmit the control message 315 that may be a reconfiguration message indicating that the PCI is changing to a second PCI. The UE 115 may monitor for a second set of one or more signals based on the control message 315. The UE 115 may receive a second set of one or more signals indicating the second PCI. Subsequent to receiving the second PCI (e.g., a reconfigured value for the PCI), the UE 115 may maintain the association (e.g., wireless connection) with the serving cell 305 and receive subsequent messages from the serving cell using the second PCI. The UE 115 may communicate one or more messages 320 with the serving cell 305 based on the second PCI.

In some examples, the control message 315 may indicate the second PCI, a time that the first PCI of the serving cell 305 is changing to the second PCI, or both. The control message 315 may include a PCI modification period. The PCI modification period indicated a duration of the time that the first PCI of the serving cell 305 is changing to the second PCI. For example, the control message 315 may notify the UE 115 of an upcoming time period in which to expect to receive a subsequent control message indicating that the first PCI of the serving cell is changing to the second PCI.

In some examples, the control message 315 may include a MIB. In some examples, the control message 315 may be a part of a MIB or another message. The control message 315 may be transmitted based on the received reports and identified matching PCI and frequency information and mismatching subsets of CGI values, as described with reference to FIG. 2. For example, the control message 315 may be sent to configure PCI reconfiguration if a DU (e.g., serving cell 305, cell-management service) determines that the reports have the same PCI and frequency information, but different subsets of CGI values, indicating that different cells are using the same PCI. That is, the DU may trigger a PCI reconfiguration after identifying a PCI conflict.

In some examples, the UE 115 may be in an active state. The UE 115 may receive the control message 315 including the MIB including a subset of the CGI, and confirm that the cell is the serving cell 305 and that the cell identity of the serving cell 305 has changed from the first PCI to the second PCI. The UE 115 may confirm without reconnecting or performing a handover procedure. In some examples, the control message 315 may include a SIB.

In some examples, the one or more messages 320 may include a MIB, another communication, or both, and may be scrambled. For example, one or more other communications may be scrambled according to both the PCI and the subset of the CGI. In some other examples, the one or more messages 320 may be scrambled according to the first PCI or the second PCI. The one or more message 320 may include the MIB, one or more other communications, or a combination thereof. The one or more messages 320 may be communicated by the serving cell 305, the UE 115, or both. For example, at least a portion of the one or more messages 320 may be scrambled according to the first PCI if the message 320 is transmitted prior to a time indicated in the control message 215 for changing of the first PCI to the second PCI. That is, if the message 320 is transmitted before the time of the indicated change, the message 320 may be scrambled according to the first PCI. In some examples, the message 320 may be scrambled according to the first PCI, and a retransmission of the message 320 may be transmitted after the change of the first PCI to the second PCI and be scrambled according to the first PCI.

In another example, the UE 115 may communicate one or more messages 320 scrambled according to the second PCI. For example, the one or more messages may be scrambled after the time indicated by the control message 315 for changing of the first PCI to the second PCI, and thus scrambled according to the second PCI.

FIG. 4 shows an example of a process flow 400 that supports fast PCI conflict detection and resolution in accordance with one or more aspects of the present disclosure. The process flow 400 may implement one or more aspects of the wireless communications systems shown and described with reference to FIGS. 1 through 3. For example, the process flow 400 includes a serving cell 405, UE 115-f, and neighboring cell 410, which may be examples of corresponding elements shown and described with reference to FIGS. 2 and 3. In the following description of the process flow 400, operations between the serving cell 405, the UE 115-f, and the neighboring cell 410 may be added, omitted, or performed in a different order (with respect to the exemplary order shown).

At 405, the UE 115-f may receive signaling from the neighboring cell 410. The signaling may include a MIB or a SIB including a subset of the CGI value or a hash of the CGI value (e.g., short CGI, shortened CGI, portion of a CGI).

At 410, the UE 115-f may transmit a report to the serving cell 405. The report may include at least the subset of the CGI value or the hash of the CGI value (e.g., the value received from the neighboring cell 410). In some examples, the report may be a mobile history report, or a measurement report. In some examples, the subset of the CGI value or the hash of the CGI value may be a shortened CGI value (e.g., a short CGI that includes fewer bits than a full CGI).

At 415, the UE 115-f may receive, and the serving cell 405 may transmit, a MIB and a SIB, where the MIB comprises a first portion of a subset of a CGI value and the SIB comprises a second portion of the subset of the CGI value. In some examples, the first portion of the CGI included in the MIB and the second portion of the CGI included in the SIB may be combined, or concatenated, to contain the entire CGI.

At 420, the serving cell 405 may determine a PCI conflict. For example, the serving cell 405 may determine that report from the UE 115-f indicated matching PCI and frequency information and mismatching subsets of CGI values.

At 425, the serving cell 405 may transmit, and the UE 115-f may receive, a first set of one or more signals indicating a first PCI of the serving cell 405. The one or more signals may include a MIB, a SIB, a configuration message, a control message, other communication, a data message, or any combination thereof.

At 430, the UE 115-f may transmit, and the serving cell 405 may receive, a first message, or transmission, where at least a portion of the first message is scrambled according the first PCI.

At 435, the serving cell 405 may transmit, and the UE 115-f may receive, a control message. The control message may be received by the UE 115-f subsequent to the receipt of the first set of one or more signals, the control message indicating that the first PCI of the serving cell 405 is changing to a second PCI. In some examples, the control message may indicate the second PCI, or may indicate a time period in which another set will be sent to indicate the second PCI.

In some examples, the control message may include a MIB indicating that the first PCI of the serving cell 506 is changing to the second PCI. The control message may be received based at least in part on the report indicating matching PCI and frequency information and mismatching subsets of CGI values. In some examples, the control message may include a time for changing of the first PCI to the second PCI. In some examples, the control message may be a part of a MIB or another message.

In some examples, the control message may indicate indicates the second PCI, a time that the first PCI of the serving cell is changing to the second PCI, or both. The control message may include an indication of a PCI modification period, the PCI modification period indicates a duration of time that the first PCI of the serving cell is changing to the second PCI.

At 440, the UE 115-f may monitor for a second set of one or more signals indicating the second PCI based at least in part on the control message. The second set of one or more signals may include a MIB, a SIB, a configuration message, a control message, a data message (e.g., having at least a portion of the data message scrambled by the second PCI), other communication, or any combination thereof. In some examples, the second set of one or more signals may be transmitted during a time period indicated in the control message, where the control message indicates that the PCI change is going to occur during the time period and the second set of one or more signals will indicate the second PCI.

At 445, the UE 115-f may receive, the serving cell 405, may transmit, the second set of one or more signals indicating the second PCI based on the control message. The UE 115-f may receive the second set of one or more signals based at least in part on the control message.

At 450, the UE 115-f and the serving cell 405 may communicate one or more messages based on the second PCI. In some examples, at least a portion of the one or more messages is scrambled according the first PCI prior to a time indicated in the control message for changing of the first PCI to the second PCI. In some other examples, wherein at least a portion of the one or more messages is scrambled according the second PCI after a time indicated in the control message for changing of the first PCI to the second PCI. In some examples, at least a portion of the one or more messages is scrambled according the second PCI, a subset of a CGI value of the serving cell, a hash of the CGI value, or any combination thereof.

At 455, the UE 115-f may transmit, and the serving cell 405 may receive, a retransmission, or a second message that is a retransmission of the first message, wherein at least a portion of the second message is scrambled according the first PCI after a time indicated in the control message for changing of the first PCI to the second PCI.

At 460, the UE 115-f may transition from an idle state to an active state in accordance with a discontinuous reception cycle.

At 465, The UE 115-f may perform a cell selection procedure to select a cell for wireless connectivity subsequent to transitioning from an idle state to an active state in accordance with a discontinuous reception cycle. The UE 115-f may receive, from a cell, such as at 415, a SIB or including a CGI value, or a MIB including a subset of the CGI. The UE 115-f may confirm, based on the CGI value or the subset of the CGI value, that the cell is the serving cell 405 and that a cell identity of the serving cell 405 has changed from the first PCI to the second PCI.

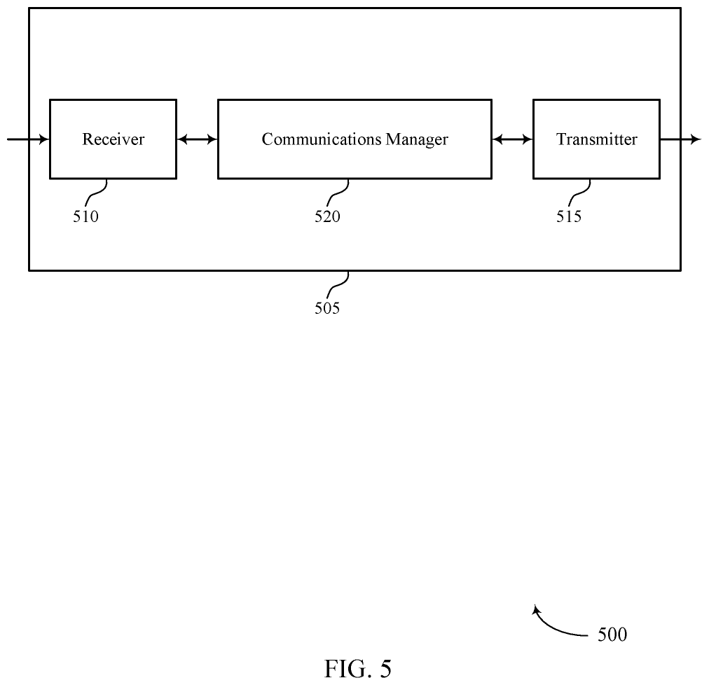

FIG. 5 shows a block diagram 500 of a device 505 that supports fast PCI conflict detection and resolution in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to fast PCI conflict detection and resolution). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to fast PCI conflict detection and resolution). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of fast PCI conflict detection and resolution as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving, via a serving cell, a first set of one or more signals indicating a first PCI of the serving cell. The communications manager 520 is capable of, configured to, or operable to support a means for receiving, via the serving cell subsequent to receipt of the first set of one or more signals, a control message indicating that the first PCI of the serving cell is changing to a second PCI. The communications manager 520 is capable of, configured to, or operable to support a means for monitoring for a second set of one or more signals indicating the second PCI based on the control message.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for fast PCI conflict detection, which may result in various advantages, such as more efficient utilization of communication resources, improved coordination between devices, reduced processing, reduced power consumption, and more efficient utilization of communication resources.

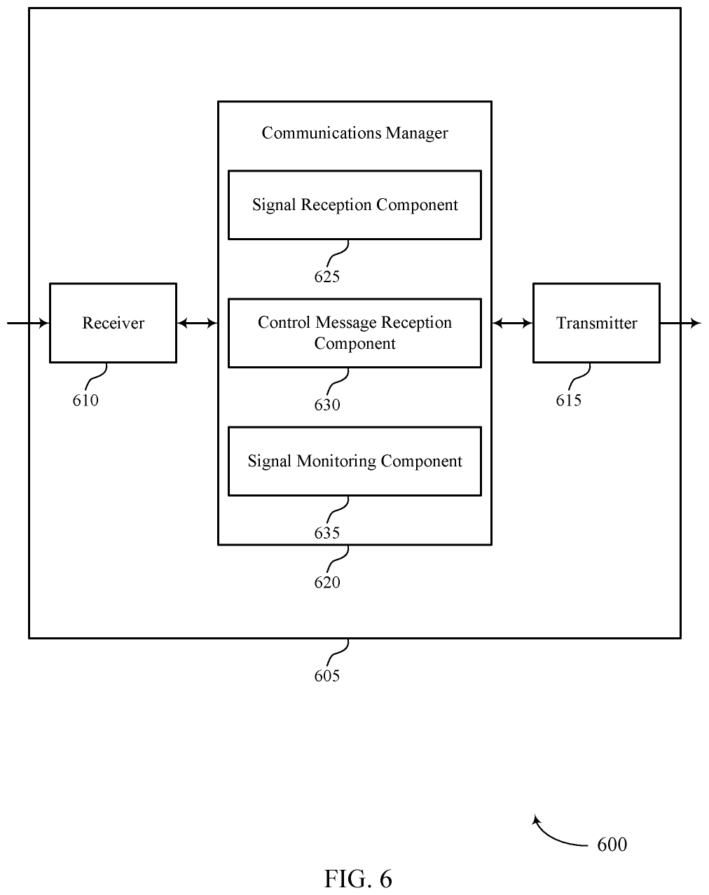

FIG. 6 shows a block diagram 600 of a device 605 that supports fast PCI conflict detection and resolution in accordance with one or more aspects of the present disclosure. The device 605 may be an example of aspects of a device 505 or a UE 115 as described herein. The device 605 may include a receiver 610, a transmitter 615, and a communications manager 620. The device 605, or one of more components of the device 605 (e.g., the receiver 610, the transmitter 615, and the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to fast PCI conflict detection and resolution). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to fast PCI conflict detection and resolution). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of fast PCI conflict detection and resolution as described herein. For example, the communications manager 620 may include a signal reception component 625, a control message reception component 630, a signal monitoring component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The signal reception component 625 is capable of, configured to, or operable to support a means for receiving, via a serving cell, a first set of one or more signals indicating a first PCI of the serving cell. The control message reception component 630 is capable of, configured to, or operable to support a means for receiving, via the serving cell subsequent to receipt of the first set of one or more signals, a control message indicating that the first PCI of the serving cell is changing to a second PCI. The signal monitoring component 635 is capable of, configured to, or operable to support a means for monitoring for a second set of one or more signals indicating the second PCI based on the control message.

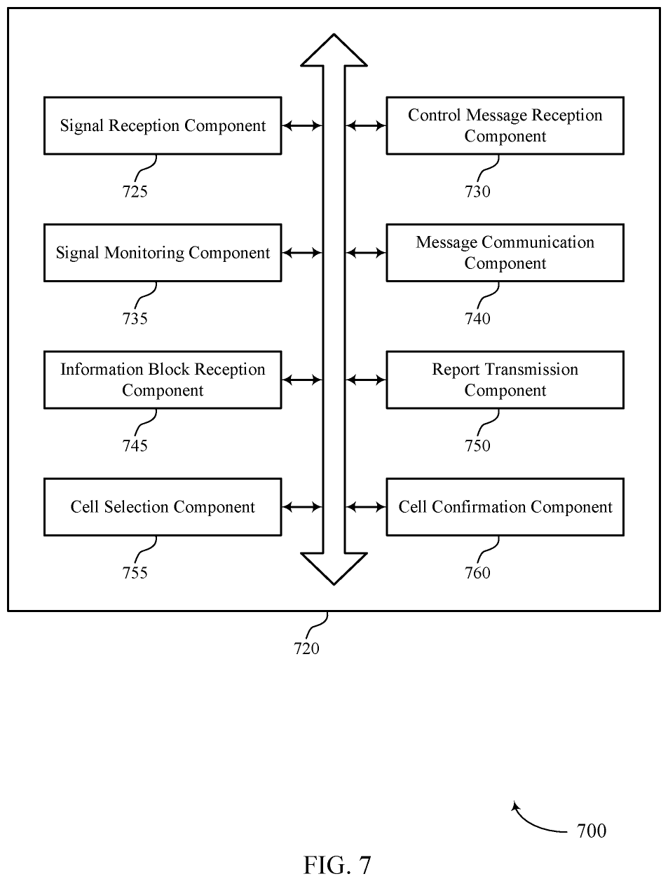

FIG. 7 shows a block diagram 700 of a communications manager 720 that supports fast PCI conflict detection and resolution in accordance with one or more aspects of the present disclosure. The communications manager 720 may be an example of aspects of a communications manager 520, a communications manager 620, or both, as described herein. The communications manager 720, or various components thereof, may be an example of means for performing various aspects of fast PCI conflict detection and resolution as described herein. For example, the communications manager 720 may include a signal reception component 725, a control message reception component 730, a signal monitoring component 735, a message communication component 740, an information block reception component 745, a report transmission component 750, a cell selection component 755, a cell confirmation component 760, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The signal reception component 725 is capable of, configured to, or operable to support a means for receiving, via a serving cell, a first set of one or more signals indicating a first PCI of the serving cell. The control message reception component 730 is capable of, configured to, or operable to support a means for receiving, via the serving cell subsequent to receipt of the first set of one or more signals, a control message indicating that the first PCI of the serving cell is changing to a second PCI. The signal monitoring component 735 is capable of, configured to, or operable to support a means for monitoring for a second set of one or more signals indicating the second PCI based on the control message.

In some examples, the signal reception component 725 is capable of, configured to, or operable to support a means for receiving the second set of one or more signals indicating the second PCI based on the control message. In some examples, the message communication component 740 is capable of, configured to, or operable to support a means for communicating one or more messages with the serving cell based on the second PCI.

In some examples, the information block reception component 745 is capable of, configured to, or operable to support a means for receiving, from a neighboring cell, a master information block or a system information block including a subset of a CGI value or a hash of the CGI value.

In some examples, the report transmission component 750 is capable of, configured to, or operable to support a means for transmitting a report to the serving cell including at least the subset of the CGI value or the hash of the CGI value.

In some examples, the information block reception component 745 is capable of, configured to, or operable to support a means for receiving, from the serving cell, a master information block and a system information block, where the master information block includes a first portion of a subset of a CGI value and the system information block includes a second portion of the subset of the CGI value.

In some examples, to support receiving the control message, the information block reception component 745 is capable of, configured to, or operable to support a means for receiving, from the serving cell, a master information block indicating that the first PCI of the serving cell is changing to the second PCI.

In some examples, the report transmission component 750 is capable of, configured to, or operable to support a means for transmitting a report to the serving cell indicating at least a subset of a CGI value or a hash of the CGI value, where the control message is received based on the report indicating matching PCI and frequency information and mismatching subsets of CGI values.

In some examples, the report transmission component 750 is capable of, configured to, or operable to support a means for transmitting a mobile history report to the serving cell including at least a subset of a CGI value or a hash of the CGI value.

In some examples, the cell selection component 755 is capable of, configured to, or operable to support a means for performing a cell selection procedure to select a cell for wireless connectivity subsequent to transitioning from an idle state to an active state in accordance with a discontinuous reception cycle. In some examples, the information block reception component 745 is capable of, configured to, or operable to support a means for receiving, from the cell, a master information block including a subset of a CGI value. In some examples, the cell confirmation component 760 is capable of, configured to, or operable to support a means for confirming, based on the subset of the CGI value, that the cell is the serving cell and that a cell identity of the serving cell has changed from the first PCI to the second PCI.

In some examples, the cell selection component 755 is capable of, configured to, or operable to support a means for performing a cell selection procedure to select a cell for wireless connectivity subsequent to transitioning from an idle state to an active state in accordance with a discontinuous reception cycle. In some examples, the information block reception component 745 is capable of, configured to, or operable to support a means for receiving, from the cell, a system information block including a CGI value. In some examples, the cell confirmation component 760 is capable of, configured to, or operable to support a means for confirming, based on the CGI value, that the cell is the serving cell and that a cell identity of the serving cell has changed from the first PCI to the second PCI.

In some examples, the message communication component 740 is capable of, configured to, or operable to support a means for communicating one or more messages, where at least a portion of the one or more messages is scrambled according the first PCI prior to a time indicated in the control message for changing of the first PCI to the second PCI.

In some examples, the message communication component 740 is capable of, configured to, or operable to support a means for communicating one or more messages, where at least a portion of the one or more messages is scrambled according the second PCI after a time indicated in the control message for changing of the first PCI to the second PCI.

In some examples, the signal reception component 725 is capable of, configured to, or operable to support a means for receiving the second set of one or more signals indicating the second PCI based on the control message.

In some examples, the message communication component 740 is capable of, configured to, or operable to support a means for transmitting a first message, where at least a portion of the first message is scrambled according the first PCI. In some examples, the message communication component 740 is capable of, configured to, or operable to support a means for transmitting a second message that is a retransmission of the first message, where at least a portion of the second message is scrambled according the first PCI after a time indicated in the control message for changing of the first PCI to the second PCI.

In some examples, the message communication component 740 is capable of, configured to, or operable to support a means for communicating one or more messages, where at least a portion of the one or more messages is scrambled according the second PCI, a subset of a CGI value of the serving cell, a hash of the CGI value, or any combination thereof.

In some examples, the control message is part of a master information block or other message. In some examples, the control message indicates the second PCI, a time that the first PCI of the serving cell is changing to the second PCI, or both.

In some examples, the control message includes an indication of a PCI modification period, the PCI modification period indicates a duration of time that the first PCI of the serving cell is changing to the second PCI.

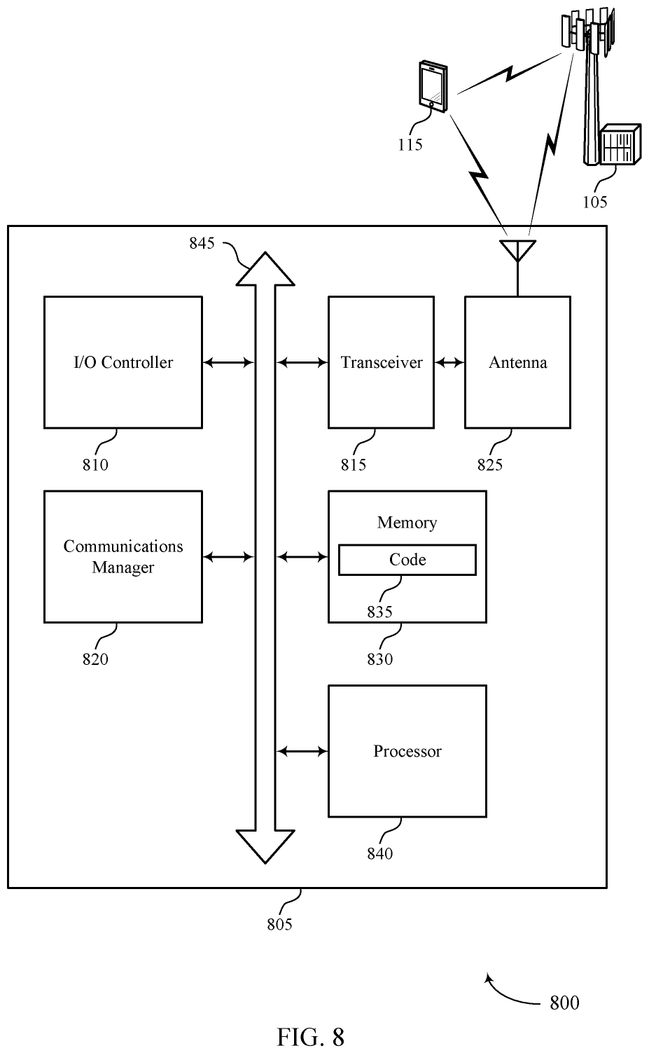

FIG. 8 shows a diagram of a system 800 including a device 805 that supports fast PCI conflict detection and resolution in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable code 835 including instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may contain, among other things, a basic I/O system (BIOS) which may control basic hardware or software operation such as the interaction with peripheral components or devices.

The at least one processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting fast PCI conflict detection and resolution). For example, the device 805 or a component of the device 805 may include at least one processor 840 and at least one memory 830 coupled with or to the at least one processor 840, the at least one processor 840 and at least one memory 830 configured to perform various functions described herein. In some examples, the at least one processor 840 may include multiple processors and the at least one memory 830 may include multiple memories. One or more of the multiple processors may be coupled with one or more of the multiple memories, which may, individually or collectively, be configured to perform various functions herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. As such, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving, via a serving cell, a first set of one or more signals indicating a first PCI of the serving cell. The communications manager 820 is capable of, configured to, or operable to support a means for receiving, via the serving cell subsequent to receipt of the first set of one or more signals, a control message indicating that the first PCI of the serving cell is changing to a second PCI. The communications manager 820 is capable of, configured to, or operable to support a means for monitoring for a second set of one or more signals indicating the second PCI based on the control message.

By including or configuring the communications manager 820 in accordance with examples as described herein, the device 805 may support techniques for fast PCI conflict detection, which may result in various advantages, such as improved communication reliability, reduced latency, improved user experience related to reduced processing, reduced power consumption, more efficient utilization of communication resources, improved coordination between devices, longer battery life, and improved utilization of processing capability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of fast PCI conflict detection and resolution as described herein, or the at least one processor 840 and the at least one memory 830 may be otherwise configured to, individually or collectively, perform or support such operations.

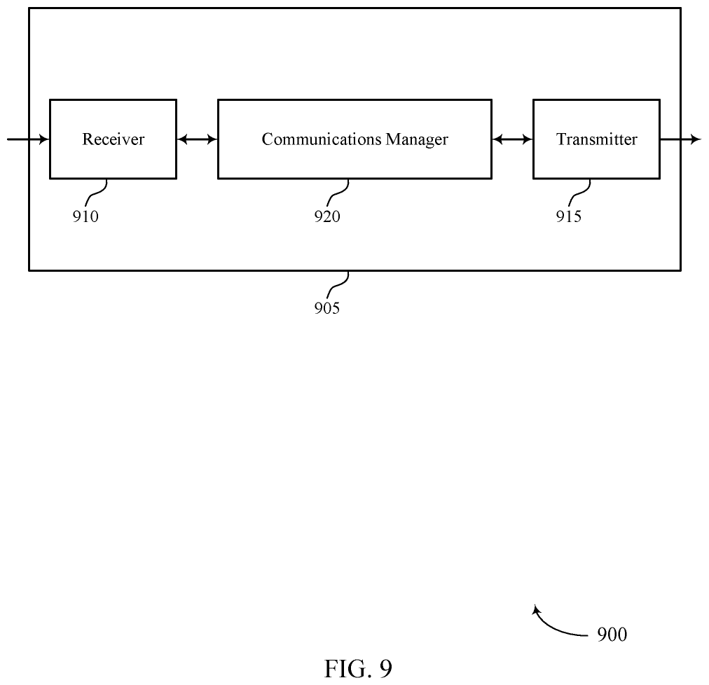

FIG. 9 shows a block diagram 900 of a device 905 that supports fast PCI conflict detection and resolution in accordance with one or more aspects of the present disclosure. The device 905 may be an example of aspects of a serving cell as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of fast PCI conflict detection and resolution as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor. If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for transmitting, to a UE, a first set of one or more signals indicating a first PCI of the serving cell. The communications manager 920 is capable of, configured to, or operable to support a means for transmitting, subsequent to transmission of the first set of one or more signals, a control message indicating that the first PCI of the serving cell is changing to a second PCI. The communications manager 920 is capable of, configured to, or operable to support a means for communicating one or more messages with the UE based on the second PCI.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for fast PCI conflict detection, which may result in various advantages, such as reduced processing, reduced power consumption, improved coordination between devices, and more efficient utilization of communication resources.

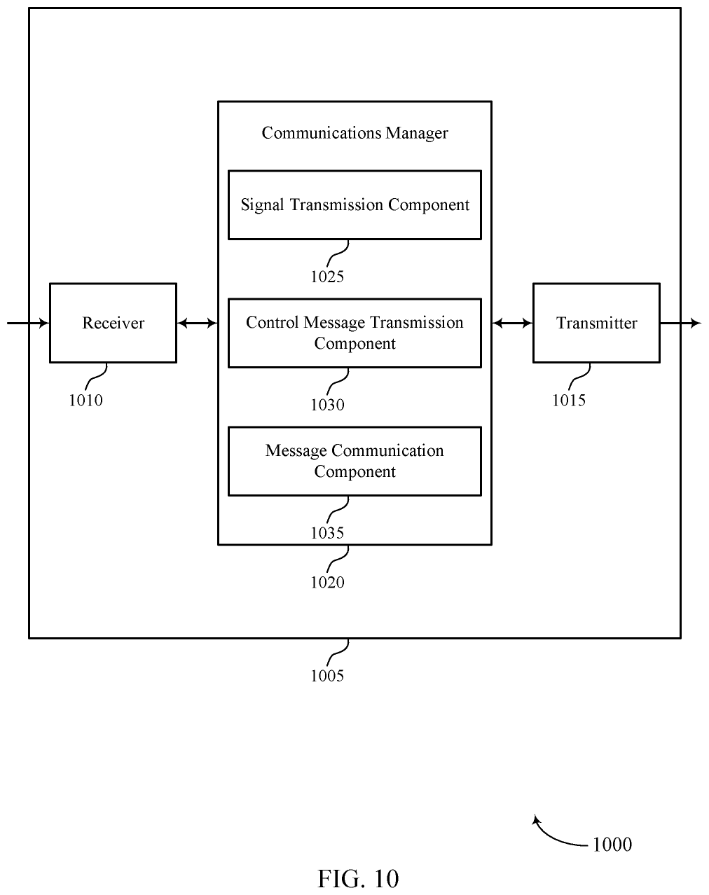

FIG. 10 shows a block diagram 1000 of a device 1005 that supports fast PCI conflict detection and resolution in accordance with one or more aspects of the present disclosure. The device 1005 may be an example of aspects of a device 905 or a serving cell as described herein. The device 1005 may include a receiver 1010, a transmitter 1015, and a communications manager 1020. The device 1005, or one of more components of the device 1005 (e.g., the receiver 1010, the transmitter 1015, and the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of fast PCI conflict detection and resolution as described herein. For example, the communications manager 1020 may include a signal transmission component 1025, a control message transmission component 1030, a message communication component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The signal transmission component 1025 is capable of, configured to, or operable to support a means for transmitting, to a UE, a first set of one or more signals indicating a first PCI of the serving cell. The control message transmission component 1030 is capable of, configured to, or operable to support a means for transmitting, subsequent to transmission of the first set of one or more signals, a control message indicating that the first PCI of the serving cell is changing to a second PCI. The message communication component 1035 is capable of, configured to, or operable to support a means for communicating one or more messages with the UE based on the second PCI.

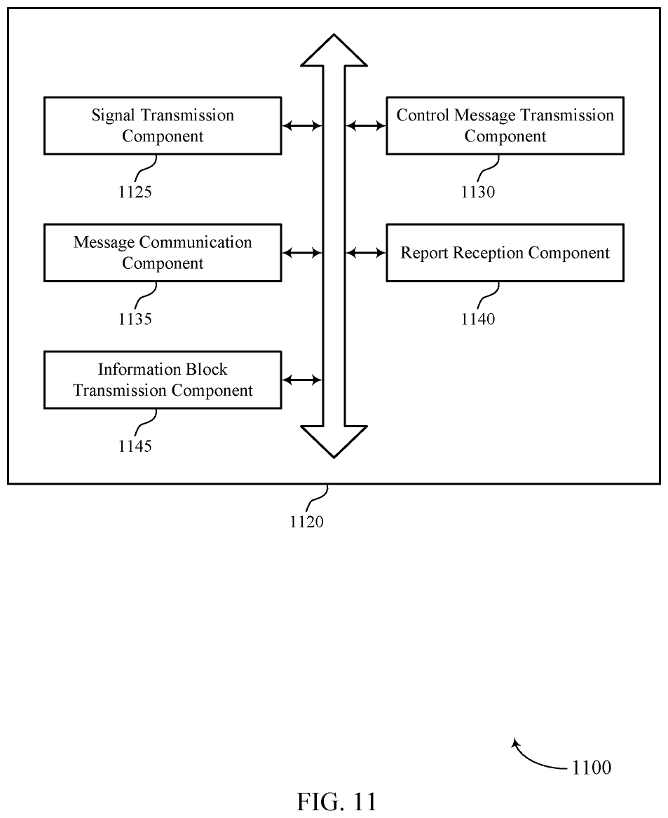

FIG. 11 shows a block diagram 1100 of a communications manager 1120 that supports fast PCI conflict detection and resolution in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of fast PCI conflict detection and resolution as described herein. For example, the communications manager 1120 may include a signal transmission component 1125, a control message transmission component 1130, a message communication component 1135, a report reception component 1140, an information block transmission component 1145, or any combination thereof. Each of these components, or components or subcomponents thereof (e.g., one or more processors, one or more memories), may communicate, directly or indirectly, with one another (e.g., via one or more buses).

The communications manager 1120 may support wireless communications in accordance with examples as disclosed herein. The signal transmission component 1125 is capable of, configured to, or operable to support a means for transmitting, to a UE, a first set of one or more signals indicating a first PCI of the serving cell. The control message transmission component 1130 is capable of, configured to, or operable to support a means for transmitting, subsequent to transmission of the first set of one or more signals, a control message indicating that the first PCI of the serving cell is changing to a second PCI. The message communication component 1135 is capable of, configured to, or operable to support a means for communicating one or more messages with the UE based on the second PCI.

In some examples, the signal transmission component 1125 is capable of, configured to, or operable to support a means for transmitting a second set of one or more signals indicating the second PCI based on the control message.

In some examples, the report reception component 1140 is capable of, configured to, or operable to support a means for receiving a report from the UE indicating at least a subset of a CGI value or a hash of the CGI value.

In some examples, the information block transmission component 1145 is capable of, configured to, or operable to support a means for transmitting, to the UE, a master information block and a system information block, where the master information block includes a first portion of a subset of a CGI value and the system information block includes a second portion of the subset of the CGI value.

In some examples, to support transmitting the control message, the information block transmission component 1145 is capable of, configured to, or operable to support a means for transmitting, to the UE, a master information block indicating that the first PCI of the serving cell is changing to the second PCI.

In some examples, the report reception component 1140 is capable of, configured to, or operable to support a means for receiving a report from the UE indicating at least a subset of a CGI value or a hash of the CGI value, where the control message is transmitted based on the report indicating matching PCI and frequency information and mismatching subsets of CGI values.

In some examples, the report reception component 1140 is capable of, configured to, or operable to support a means for receiving a mobile history report from the UE including at least a subset of a CGI value or a hash of the CGI value.

In some examples, the message communication component 1135 is capable of, configured to, or operable to support a means for communicating one or more messages, where at least a portion of the one or more messages is scrambled according the first PCI prior to a time indicated in the control message for changing of the first PCI to the second PCI.

In some examples, the message communication component 1135 is capable of, configured to, or operable to support a means for communicating one or more messages, where at least a portion of the one or more messages is scrambled according the second PCI after a time indicated in the control message for changing of the first PCI to the second PCI.

In some examples, the message communication component 1135 is capable of, configured to, or operable to support a means for communicating one or more messages, where at least a portion of the one or more messages is scrambled according the second PCI, a subset of a CGI value of the serving cell, a hash of the CGI value, or any combination thereof.

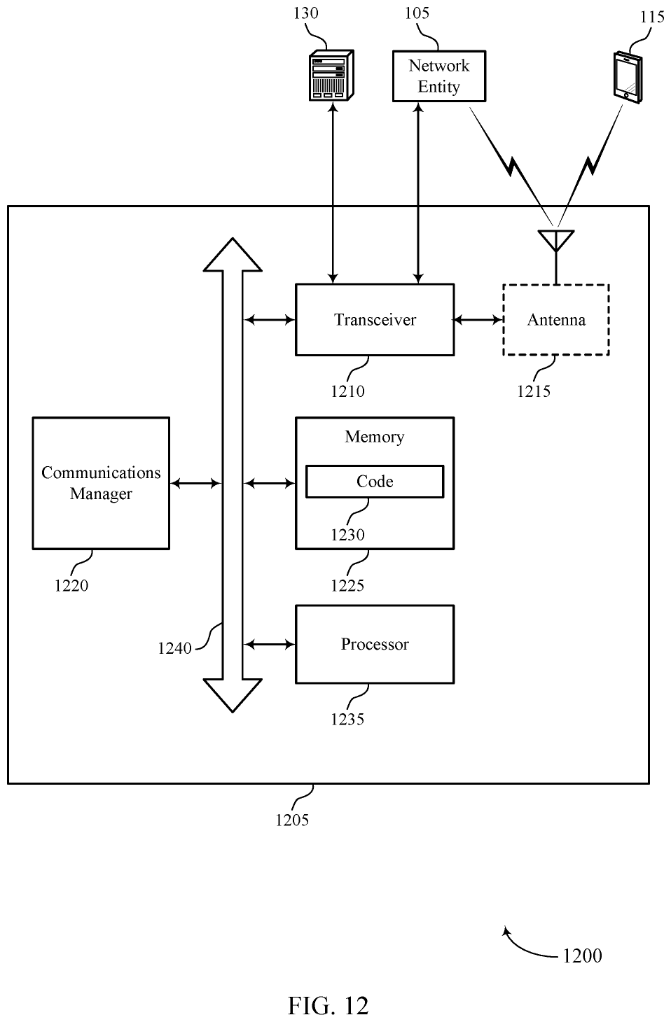

FIG. 12 shows a diagram of a system 1200 including a device 1205 that supports fast PCI conflict detection and resolution in accordance with one or more aspects of the present disclosure. The device 1205 may be an example of or include the components of a device 905, a device 1005, or a serving cell as described herein. The device 1205 may include components for bi-directional voice and data communications including components for transmitting and receiving communications, such as a communications manager 1220, a transceiver 1210, an antenna 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., a communication link 125, a backhaul communication link 120, a midhaul communication link 162, a fronthaul communication link 168).

The at least one memory 1225 may include RAM, ROM, or any combination thereof. The at least one memory 1225 may store computer-readable, computer-executable code 1230 including instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may contain, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting fast PCI conflict detection and resolution). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225). In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. As such, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for transmitting, to a UE, a first set of one or more signals indicating a first PCI of the serving cell. The communications manager 1220 is capable of, configured to, or operable to support a means for transmitting, subsequent to transmission of the first set of one or more signals, a control message indicating that the first PCI of the serving cell is changing to a second PCI. The communications manager 1220 is capable of, configured to, or operable to support a means for communicating one or more messages with the UE based on the second PCI.

By including or configuring the communications manager 1220 in accordance with examples as described herein, the device 1205 may support techniques for fast PCI conflict detection, which may result in various advantages, such as improved communication reliability, reduced latency, improved user experience related to reduced processing, reduced power consumption, more efficient utilization of communication resources, improved coordination between devices, longer battery life, and improved utilization of processing capability.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of fast PCI conflict detection and resolution as described herein, or the at least one processor 1235 and the at least one memory 1225 may be otherwise configured to, individually or collectively, perform or support such operations.

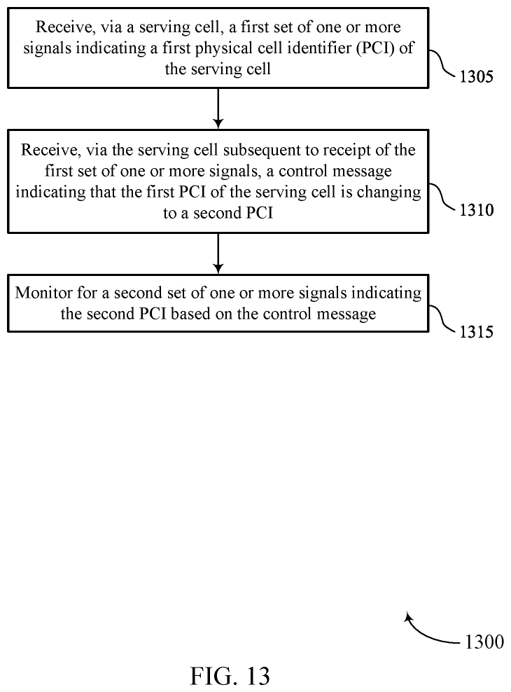

FIG. 13 shows a flowchart illustrating a method 1300 that supports fast PCI conflict detection and resolution in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving, via a serving cell, a first set of one or more signals indicating a first PCI of the serving cell. The operations of block 1305 may be performed in accordance with examples as disclosed herein. In some examples, aspects of the operations of 1305 may be performed by a signal reception component 725 as described with reference to FIG. 7.

At 1310, the method may include receiving, via the serving cell subsequent to receipt of the first set of one or more signals, a control message indicating that the first PCI of the serving cell is changing to a second PCI. The operations of block 1310 may be performed in accordance with examples as disclosed herein. In some examples, aspects of the operations of 1310 may be performed by a control message reception component 730 as described with reference to FIG. 7.

At 1315, the method may include monitoring for a second set of one or more signals indicating the second PCI based on the control message. The operations of block 1315 may be performed in accordance with examples as disclosed herein. In some examples, aspects of the operations of 1315 may be performed by a signal monitoring component 735 as described with reference to FIG. 7.

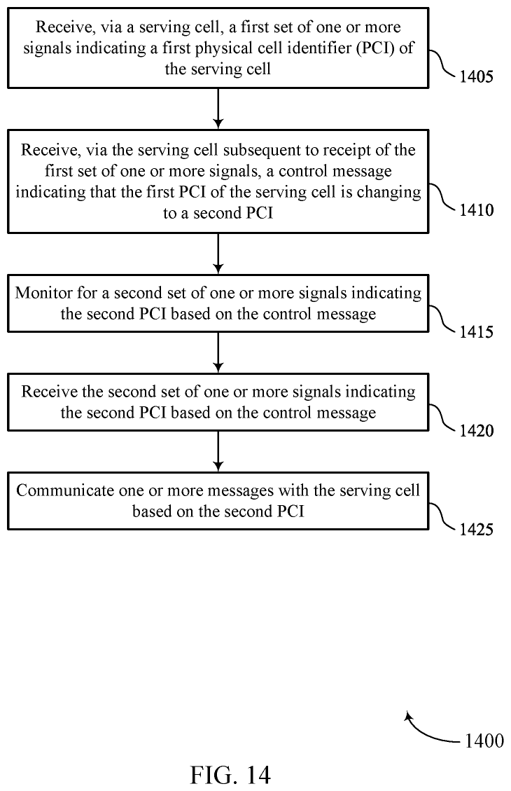

FIG. 14 shows a flowchart illustrating a method 1400 that supports fast PCI conflict detection and resolution in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving, via a serving cell, a first set of one or more signals indicating a first PCI of the serving cell. The operations of block 1405 may be performed in accordance with examples as disclosed herein. In some examples, aspects of the operations of 1405 may be performed by a signal reception component 725 as described with reference to FIG. 7.

At 1410, the method may include receiving, via the serving cell subsequent to receipt of the first set of one or more signals, a control message indicating that the first PCI of the serving cell is changing to a second PCI. The operations of block 1410 may be performed in accordance with examples as disclosed herein. In some examples, aspects of the operations of 1410 may be performed by a control message reception component 730 as described with reference to FIG. 7.

At 1415, the method may include monitoring for a second set of one or more signals indicating the second PCI based on the control message. The operations of block 1415 may be performed in accordance with examples as disclosed herein. In some examples, aspects of the operations of 1415 may be performed by a signal monitoring component 735 as described with reference to FIG. 7.

At 1420, the method may include receiving the second set of one or more signals indicating the second PCI based on the control message. The operations of block 1420 may be performed in accordance with examples as disclosed herein. In some examples, aspects of the operations of 1420 may be performed by a signal reception component 725 as described with reference to FIG. 7.

At 1425, the method may include communicating one or more messages with the serving cell based on the second PCI. The operations of block 1425 may be performed in accordance with examples as disclosed herein. In some examples, aspects of the operations of 1425 may be performed by a message communication component 740 as described with reference to FIG. 7.

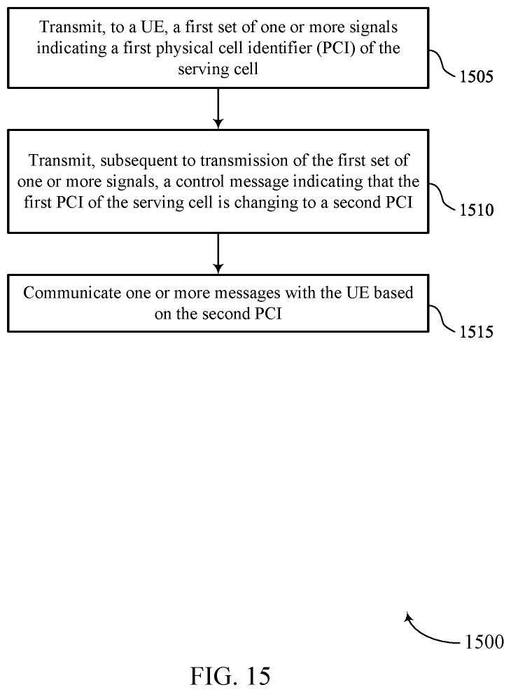

FIG. 15 shows a flowchart illustrating a method 1500 that supports fast PCI conflict detection and resolution in accordance with aspects of the present disclosure. The operations of the method 1500 may be implemented by a serving cell or its components as described herein. For example, the operations of the method 1500 may be performed by a serving cell as described with reference to FIGS. 1 through 4 and 9 through 12. In some examples, a serving cell may execute a set of instructions to control the functional elements of the serving cell to perform the described functions. Additionally, or alternatively, the serving cell may perform aspects of the described functions using special-purpose hardware.

At 1505, the method may include transmitting, to a UE, a first set of one or more signals indicating a first PCI of the serving cell. The operations of block 1505 may be performed in accordance with examples as disclosed herein. In some examples, aspects of the operations of 1505 may be performed by a signal transmission component 1125 as described with reference to FIG. 11.

At 1510, the method may include transmitting, subsequent to transmission of the first set of one or more signals, a control message indicating that the first PCI of the serving cell is changing to a second PCI. The operations of block 1510 may be performed in accordance with examples as disclosed herein. In some examples, aspects of the operations of 1510 may be performed by a control message transmission component 1130 as described with reference to FIG. 11.

At 1515, the method may include communicating one or more messages with the UE based on the second PCI. The operations of block 1515 may be performed in accordance with examples as disclosed herein. In some examples, aspects of the operations of 1515 may be performed by a message communication component 1135 as described with reference to FIG. 11.

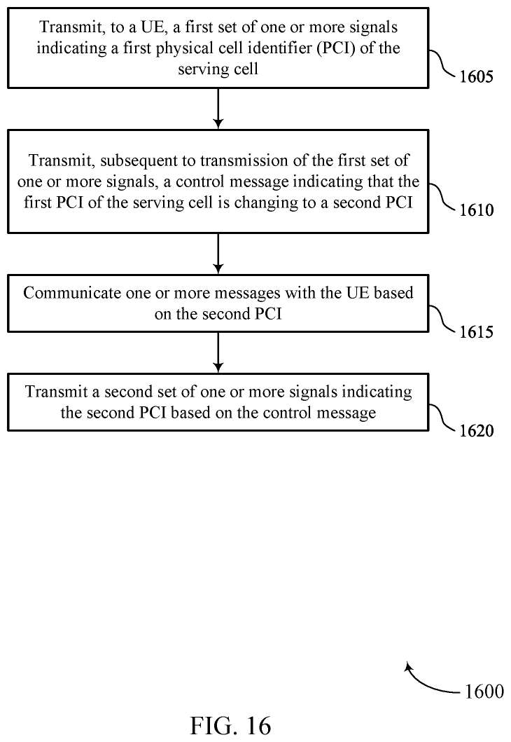

FIG. 16 shows a flowchart illustrating a method 1600 that supports fast PCI conflict detection and resolution in accordance with aspects of the present disclosure. The operations of the method 1600 may be implemented by a serving cell or its components as described herein. For example, the operations of the method 1600 may be performed by a serving cell as described with reference to FIGS. 1 through 4 and 9 through 12. In some examples, a serving cell may execute a set of instructions to control the functional elements of the serving cell to perform the described functions. Additionally, or alternatively, the serving cell may perform aspects of the described functions using special-purpose hardware.

At 1605, the method may include transmitting, to a UE, a first set of one or more signals indicating a first PCI of the serving cell. The operations of block 1605 may be performed in accordance with examples as disclosed herein. In some examples, aspects of the operations of 1605 may be performed by a signal transmission component 1125 as described with reference to FIG. 11.

At 1610, the method may include transmitting, subsequent to transmission of the first set of one or more signals, a control message indicating that the first PCI of the serving cell is changing to a second PCI. The operations of block 1610 may be performed in accordance with examples as disclosed herein. In some examples, aspects of the operations of 1610 may be performed by a control message transmission component 1130 as described with reference to FIG. 11.

At 1615, the method may include communicating one or more messages with the UE based on the second PCI. The operations of block 1615 may be performed in accordance with examples as disclosed herein. In some examples, aspects of the operations of 1615 may be performed by a message communication component 1135 as described with reference to FIG. 11.

At 1620, the method may include transmitting a second set of one or more signals indicating the second PCI based on the control message. The operations of block 1620 may be performed in accordance with examples as disclosed herein. In some examples, aspects of the operations of 1620 may be performed by a signal transmission component 1125 as described with reference to FIG. 11.

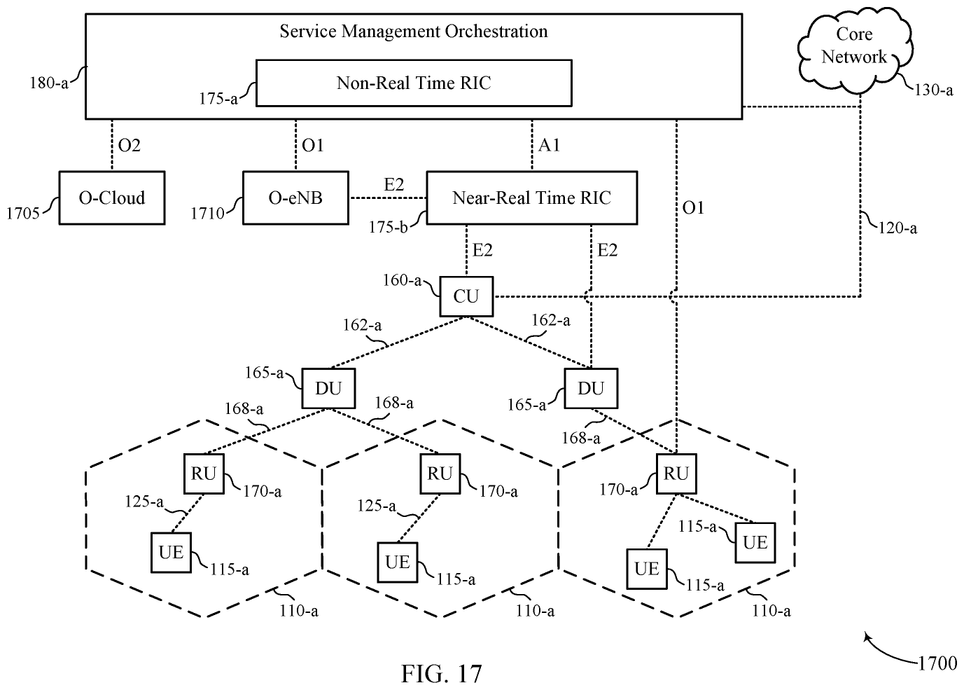

FIG. 17 shows an example of a network architecture 1700 (e.g., a disaggregated base station architecture, a disaggregated RAN architecture) that supports techniques for relaying inter-CU communications in accordance with one or more aspects of the present disclosure. The network architecture 1700 may illustrate an example for implementing one or more aspects of the wireless communications system 100. The network architecture 1700 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 1700 (e.g., CUs 160-a, DUs 165-a. RUs 170-a, Non-RT RICs 175-a, Near-RT RICs 175-b, SMOs 180-a, Open Clouds (O-Clouds) 1705, Open eNBs (O-eNBs) 1710) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 1705) to perform network entity life cycle management (e.g., to instantiate virtualized network entities 105) via a cloud computing platform interface (e.g., an 02 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 1710, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

The following provides an overview of aspects of the present disclosure:
Aspect 1: A method for wireless communications at a UE, comprising: receiving, via a serving cell, a first set of one or more signals indicating a first PCI of the serving cell; receiving, via the serving cell subsequent to receipt of the first set of one or more signals, a control message indicating that the first PCI of the serving cell is changing to a second PCI; and monitoring for a second set of one or more signals indicating the second PCI based at least in part on the control message.
Aspect 2: The method of aspect 1, further comprising: receiving the second set of one or more signals indicating the second PCI based at least in part on the control message; and communicating one or more messages with the serving cell based at least in part on the second PCI.
Aspect 3: The method of any of aspects 1 through 2, further comprising: receiving, from a neighboring cell, a master information block or a system information block comprising a subset of a CGI value or a hash of the CGI value.
Aspect 4: The method of aspect 3, further comprising: transmitting a report to the serving cell comprising at least the subset of the CGI value or the hash of the CGI value.
Aspect 5: The method of any of aspects 1 through 4, further comprising: receiving, from the serving cell, a master information block and a system information block, wherein the master information block comprises a first portion of a subset of a CGI value and the system information block comprises a second portion of the subset of the CGI value.
Aspect 6: The method of any of aspects 1 through 5, wherein receiving the control message further comprises: receiving, from the serving cell, a master information block indicating that the first PCI of the serving cell is changing to the second PCI.
Aspect 7: The method of any of aspects 1 through 6, further comprising: transmitting a report to the serving cell indicating at least a subset of a CGI value or a hash of the CGI value, wherein the control message is received based at least in part on the report indicating matching PCI and frequency information and mismatching subsets of CGI values.
Aspect 8: The method of any of aspects 1 through 7, further comprising: transmitting a mobile history report to the serving cell comprising at least a subset of a CGI value or a hash of the CGI value.
Aspect 9: The method of any of aspects 1 through 8, further comprising: performing a cell selection procedure to select a cell for wireless connectivity subsequent to transitioning from an idle state to an active state in accordance with a discontinuous reception cycle; receiving, from the cell, a master information block comprising a subset of a CGI value; and confirming, based at least in part on the subset of the CGI value, that the cell is the serving cell and that a cell identity of the serving cell has changed from the first PCI to the second PCI.
Aspect 10: The method of any of aspects 1 through 9, further comprising: performing a cell selection procedure to select a cell for wireless connectivity subsequent to transitioning from an idle state to an active state in accordance with a discontinuous reception cycle; receiving, from the cell, a system information block comprising a CGI value; and confirming, based at least in part on the CGI value, that the cell is the serving cell and that a cell identity of the serving cell has changed from the first PCI to the second PCI.
Aspect 11: The method of any of aspects 1 through 10, further comprising: communicating one or more messages, wherein at least a portion of the one or more messages is scrambled according the first PCI prior to a time indicated in the control message for changing of the first PCI to the second PCI.
Aspect 12: The method of any of aspects 1 through 11, further comprising: communicating one or more messages, wherein at least a portion of the one or more messages is scrambled according the second PCI after a time indicated in the control message for changing of the first PCI to the second PCI.
Aspect 13: The method of any of aspects 1 through 12, further comprising: receiving the second set of one or more signals indicating the second PCI based at least in part on the control message.
Aspect 14: The method of aspect 13, further comprising: transmitting a first message, wherein at least a portion of the first message is scrambled according the first PCI; and transmitting a second message that is a retransmission of the first message, wherein at least a portion of the second message is scrambled according the first PCI after a time indicated in the control message for changing of the first PCI to the second PCI.
Aspect 15: The method of any of aspects 1 through 14, further comprising: communicating one or more messages, wherein at least a portion of the one or more messages is scrambled according the second PCI, a subset of a CGI value of the serving cell, a hash of the CGI value, or any combination thereof.
Aspect 16: The method of any of aspects 1 through 15, wherein the control message is part of a master information block or other message.
Aspect 17: The method of any of aspects 1 through 16, wherein the control message indicates the second PCI, a time that the first PCI of the serving cell is changing to the second PCI, or both.
Aspect 18: The method of any of aspects 1 through 17, wherein the control message comprises an indication of a PCI modification period, the PCI modification period indicates a duration of time that the first PCI of the serving cell is changing to the second PCI.
Aspect 19: A method for wireless communications at a serving cell, comprising: transmitting, to a UE, a first set of one or more signals indicating a first PCI of the serving cell; transmitting, subsequent to transmission of the first set of one or more signals, a control message indicating that the first PCI of the serving cell is changing to a second PCI; and communicating one or more messages with the UE based at least in part on the second PCI.
Aspect 20: The method of aspect 19, further comprising: transmitting a second set of one or more signals indicating the second PCI based at least in part on the control message.
Aspect 21: The method of any of aspects 19 through 20, further comprising: receiving a report from the UE indicating at least a subset of a CGI value or a hash of the CGI value.
Aspect 22: The method of any of aspects 19 through 21, further comprising: transmitting, to the UE, a master information block and a system information block, wherein the master information block comprises a first portion of a subset of a CGI value and the system information block comprises a second portion of the subset of the CGI value.
Aspect 23: The method of any of aspects 19 through 22, wherein transmitting the control message further comprises: transmitting, to the UE, a master information block indicating that the first PCI of the serving cell is changing to the second PCI.
Aspect 24: The method of any of aspects 19 through 23, further comprising: receiving a report from the UE indicating at least a subset of a CGI value or a hash of the CGI value, wherein the control message is transmitted based at least in part on the report indicating matching PCI and frequency information and mismatching subsets of CGI values.
Aspect 25: The method of any of aspects 19 through 24, further comprising: receiving a mobile history report from the UE comprising at least a subset of a CGI value or a hash of the CGI value.
Aspect 26: The method of any of aspects 19 through 25, further comprising: communicating one or more messages, wherein at least a portion of the one or more messages is scrambled according the first PCI prior to a time indicated in the control message for changing of the first PCI to the second PCI.
Aspect 27: The method of any of aspects 19 through 26, further comprising: communicating one or more messages, wherein at least a portion of the one or more messages is scrambled according the second PCI after a time indicated in the control message for changing of the first PCI to the second PCI.
Aspect 28: The method of any of aspects 19 through 27, further comprising: communicating one or more messages, wherein at least a portion of the one or more messages is scrambled according the second PCI, a subset of a CGI value of the serving cell, a hash of the CGI value, or any combination thereof.
Aspect 29: A UE for wireless communications, comprising one or more memories storing processor-executable code, and one or more processors coupled with the one or more memories and individually or collectively operable to execute the code to cause the UE to perform a method of any of aspects 1 through 18.
Aspect 30: A UE for wireless communications, comprising at least one means for performing a method of any of aspects 1 through 18.
Aspect 31: A non-transitory computer-readable medium storing code for wireless communications, the code comprising instructions executable by a processor to perform a method of any of aspects 1 through 18.
Aspect 32: A serving cell for wireless communications, comprising one or more memories storing processor-executable code, and one or more processors coupled with the one or more memories and individually or collectively operable to execute the code to cause the serving cell to perform a method of any of aspects 19 through 28.
Aspect 33: A serving cell for wireless communications, comprising at least one means for performing a method of any of aspects 19 through 28.
Aspect 34: A non-transitory computer-readable medium storing code for wireless communications, the code comprising instructions executable by a processor to perform a method of any of aspects 19 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, via a serving cell, a first set of one or more signals indicating a first physical cell identifier (PCI) of the serving cell;
receive, via the serving cell subsequent to receipt of the first set of one or more signals, a control message indicating that the first PCI of the serving cell is changing to a second PCI; and
monitor for a second set of one or more signals indicating the second PCI based at least in part on the control message.

2. The UE of claim 1, wherein the one or more processors are individually or collectively further operable to execute the code to cause the UE to:
receive the second set of one or more signals indicating the second PCI based at least in part on the control message; and
communicate one or more messages with the serving cell based at least in part on the second PCI.

3. The UE of claim 1, wherein the one or more processors are individually or collectively further operable to execute the code to cause the UE to:
receive, from a neighboring cell, a master information block or a system information block comprising a subset of a cell global identity (CGI) value or a hash of the CGI value.

4. The UE of claim 3, wherein the one or more processors are individually or collectively further operable to execute the code to cause the UE to:
transmit a report to the serving cell comprising at least the subset of the CGI value or the hash of the CGI value.

5. The UE of claim 1, wherein the one or more processors are individually or collectively further operable to execute the code to cause the UE to:
receive, from the serving cell, a master information block and a system information block, wherein the master information block comprises a first portion of a subset of a cell global identity (CGI) value and the system information block comprises a second portion of the subset of the CGI value.

6. The UE of claim 1, wherein, to receive the control message, the one or more processors are individually or collectively further operable to execute the code to cause the UE to:
receive, from the serving cell, a master information block indicating that the first PCI of the serving cell is changing to the second PCI.

7. The UE of claim 1, wherein the one or more processors are individually or collectively further operable to execute the code to cause the UE to:
transmit a report to the serving cell indicating at least a subset of a cell global identity (CGI) value or a hash of the CGI value, wherein the control message is received based at least in part on the report indicating matching PCI and frequency information and mismatching subsets of CGI values.

8. The UE of claim 1, wherein the one or more processors are individually or collectively further operable to execute the code to cause the UE to:
transmit a mobile history report to the serving cell comprising at least a subset of a cell global identity (CGI) value or a hash of the CGI value.

9. The UE of claim 1, wherein the one or more processors are individually or collectively further operable to execute the code to cause the UE to:
perform a cell selection procedure to select a cell for wireless connectivity subsequent to transitioning from an idle state to an active state in accordance with a discontinuous reception cycle;
receive, from the cell, a master information block comprising a subset of a cell global identity (CGI) value; and
confirm, based at least in part on the subset of the CGI value, that the cell is the serving cell and that a cell identity of the serving cell has changed from the first PCI to the second PCI.

10. The UE of claim 1, wherein the one or more processors are individually or collectively further operable to execute the code to cause the UE to:
perform a cell selection procedure to select a cell for wireless connectivity subsequent to transitioning from an idle state to an active state in accordance with a discontinuous reception cycle;
receive, from the cell, a system information block comprising a cell global identity (CGI) value; and
confirm, based at least in part on the CGI value, that the cell is the serving cell and that a cell identity of the serving cell has changed from the first PCI to the second PCI.

11. The UE of claim 1, wherein the one or more processors are individually or collectively further operable to execute the code to cause the UE to:
communicate one or more messages, wherein at least a portion of the one or more messages is scrambled according the first PCI prior to a time indicated in the control message for changing of the first PCI to the second PCI.

12. The UE of claim 1, wherein the one or more processors are individually or collectively further operable to execute the code to cause the UE to:
communicate one or more messages, wherein at least a portion of the one or more messages is scrambled according the second PCI after a time indicated in the control message for changing of the first PCI to the second PCI.

13. The UE of claim 1, wherein the one or more processors are individually or collectively further operable to execute the code to cause the UE to:
receive the second set of one or more signals indicating the second PCI based at least in part on the control message.

14. The UE of claim 13, wherein the one or more processors are individually or collectively further operable to execute the code to cause the UE to:
transmit a first message, wherein at least a portion of the first message is scrambled according the first PCI; and
transmit a second message that is a retransmission of the first message, wherein at least a portion of the second message is scrambled according the first PCI after a time indicated in the control message for changing of the first PCI to the second PCI.

15. The UE of claim 1, wherein the one or more processors are individually or collectively further operable to execute the code to cause the UE to:
communicate one or more messages, wherein at least a portion of the one or more messages is scrambled according the second PCI, a subset of a cell global identity (CGI) value of the serving cell, a hash of the CGI value, or any combination thereof.

16. The UE of claim 1, wherein the control message is part of a master information block or other message.

17. The UE of claim 1, wherein the control message indicates the second PCI, a time that the first PCI of the serving cell is changing to the second PCI, or both.

18. The UE of claim 1, wherein the control message comprises an indication of a PCI modification period, the PCI modification period indicates a duration of time that the first PCI of the serving cell is changing to the second PCI.

19. A serving cell, comprising:
one or more memories storing processor-executable code; and
one or more processors coupled with the one or more memories and individually or collectively operable to execute the code to cause the serving cell to:
transmit, to a user equipment (UE), a first set of one or more signals indicating a first physical cell identifier (PCI) of the serving cell;
transmit, subsequent to transmission of the first set of one or more signals, a control message indicating that the first PCI of the serving cell is changing to a second PCI; and
communicate one or more messages with the UE based at least in part on the second PCI.

20. The serving cell of claim 19, wherein the one or more processors are individually or collectively further operable to execute the code to cause the serving cell to:
transmit a second set of one or more signals indicating the second PCI based at least in part on the control message.

21. The serving cell of claim 19, wherein the one or more processors are individually or collectively further operable to execute the code to cause the serving cell to:
receive a report from the UE indicating at least a subset of a cell global identity (CGI) value or a hash of the CGI value.

22. The serving cell of claim 19, wherein the one or more processors are individually or collectively further operable to execute the code to cause the serving cell to:
transmit, to the UE, a master information block and a system information block, wherein the master information block comprises a first portion of a subset of a cell global identity (CGI) value and the system information block comprises a second portion of the subset of the CGI value.

23. The serving cell of claim 19, wherein, to transmit the control message, the one or more processors are individually or collectively further operable to execute the code to cause the serving cell to:
transmit, to the UE, a master information block indicating that the first PCI of the serving cell is changing to the second PCI.

24. The serving cell of claim 19, wherein the one or more processors are individually or collectively further operable to execute the code to cause the serving cell to:
receive a report from the UE indicating at least a subset of a cell global identity (CGI) value or a hash of the CGI value, wherein the control message is transmitted based at least in part on the report indicating matching PCI and frequency information and mismatching subsets of CGI values.

25. The serving cell of claim 19, wherein the one or more processors are individually or collectively further operable to execute the code to cause the serving cell to:
receive a mobile history report from the UE comprising at least a subset of a cell global identity (CGI) value or a hash of the CGI value.

26. The serving cell of claim 19, wherein the one or more processors are individually or collectively further operable to execute the code to cause the serving cell to:
communicate one or more messages, wherein at least a portion of the one or more messages is scrambled according the first PCI prior to a time indicated in the control message for changing of the first PCI to the second PCI.

27. The serving cell of claim 19, wherein the one or more processors are individually or collectively further operable to execute the code to cause the serving cell to:
communicate one or more messages, wherein at least a portion of the one or more messages is scrambled according the second PCI after a time indicated in the control message for changing of the first PCI to the second PCI.

28. The serving cell of claim 19, wherein the one or more processors are individually or collectively further operable to execute the code to cause the serving cell to:
communicate one or more messages, wherein at least a portion of the one or more messages is scrambled according the second PCI, a subset of a cell global identity (CGI) value of the serving cell, a hash of the CGI value, or any combination thereof.

29. A method for wireless communications at a user equipment (UE), comprising:
receiving, via a serving cell, a first set of one or more signals indicating a first physical cell identifier (PCI) of the serving cell;
receiving, via the serving cell subsequent to receipt of the first set of one or more signals, a control message indicating that the first PCI of the serving cell is changing to a second PCI; and
monitoring for a second set of one or more signals indicating the second PCI based at least in part on the control message.

30. A method for wireless communications at a serving cell, comprising:
transmitting, to a user equipment (UE), a first set of one or more signals indicating a first physical cell identifier (PCI) of the serving cell;
transmitting, subsequent to transmission of the first set of one or more signals, a control message indicating that the first PCI of the serving cell is changing to a second PCI; and
communicating one or more messages with the UE based at least in part on the second PCI.
